(19) United States
(12) Patent Application Publication
(10) Pub. No.: US 2020/0387959 A1
(43) Pub. Date: Dec. 10, 2020

(54) DYNAMIC REGULATION OF ITEM AND SERVICE LEASES

(71) Applicant: Tiburon Lockers, Inc., Rockleigh, NJ (US)

(72) Inventors: Keith Louis Amdahl, Edgewater, NJ (US); Jared Lowenthal, Saddle River, NJ (US)

(73) Assignee: Tiburon Lockers, Inc., Rockleigh, NJ (US)

(21) Appl. No.: 16/409,063

(22) Filed: Jun. 5, 2019

(51) Int. Cl. G06Q 30/06; G06Q 30/02

(52) U.S. Cl. CPC G06Q 30/0645; G06Q 30/0224; G06Q 30/0269

(57) ABSTRACT

A storage system operable by a user is provided. The system includes a plurality of securable units within the housing; a processing device, the processing device being configured to assign a securable unit to the user in accordance with a lease of the assigned securable unit and to provide the user with access credentials for accessing the assigned securable unit, the processing device being configured to initially assign at least one lease parameter to the lease; and a sensor configured to (i) sense at least one trigger or characteristic after the initial lease parameter is initially assigned to the lease and (ii) communicate a sensor signal to the processing device indicative of the sensed trigger or characteristic; in which the processing device is configured to modify the at least one lease parameter in accordance with the at least one trigger or characteristic sensed by the sensor.

### FIELD OF INVENTION

The present invention relates to item and service leases and, in particular, to storage systems for leasing storage compartments at various venues.

### CROSS-REFERENCE

This application relates to co-pending patent application Ser. No. 15/084,298 entitled “ELECTRONIC STORAGE SYSTEM” and published as U.S. patent pub. no. 2017/0286649, the entire contents of both of which are expressly incorporated herein by reference.

### BACKGROUND OF THE INVENTION

It is often desirable for entertainment and other venues, such as amusement parks, concert halls, water parks and ski resorts, to provide means by which customers can securely store their personal belongings (such as smartphones, tablets, backpacks, watches, food, beverages, etc.) while visiting various attractions at the venues or engaging in other activities. Typically, such means include electronic storage systems that comprise a bank of storage compartments and a kiosk that allows a customer to lease and access one or more of the compartments for a limited amount of time using credit cards, cash or other forms of payment. After completing the lease process, the user secures his/her personal belongings in the leased compartment. To access the compartment, the user typically enters a personal identification code (e.g., a PIN or password) into the kiosk, which then opens the leased compartment electronically.

In certain circumstances, it may be desirable to provide a user with a storage compartment at a reduced cost or free of charge. For instance, it is not uncommon for venues, such as amusement parks, to permit users to lease compartments free of charge for limited durations from a limited-access electronic storage system positioned in close proximity to a particular event, such as a ride, concert, sporting event, etc. (also known as a “ride” storage system). In this way, users are encouraged to store their personal items temporarily to alleviate fear of loss or damage thereto during an event. Such a system may also promote safety with respect to events that may cause personal items to jostle free and strike other users or cause unsafe interference/hazards, such as rollercoaster rides or the like.

The duration of a limited-access ride lease is typically first determined statically (e.g., as a set time for a particular day of the week or holiday) or manually via observation of the duration of the associated event. More specifically, staff (typically employees of the venue) time the duration of an event and set the lease duration of the ride storage system accordingly via an administrative interface. Additional time necessary for a typical user to initially access his/her leased compartment and to return after the event for recovery of his/her personal belongings (known as the pre-ride wait time and after-ride lag time, respectively) also may be estimated and added to the set duration. Staff then continually monitor the event and adjust the lease duration several times per day. Needless to say, this manual procedure is time-consuming, costly and susceptible to estimation errors.

Furthermore, as described above, limited-access ride storage systems are typically offered free of charge, but are intended only to provide actual participants of an event temporary storage for the event's duration. Unfortunately, some users abuse ride storage systems by leasing compartments without intent to participate in the associated event or continuing to utilize the compartments long after an event terminates. This practice not only reduces the efficacy of ride storage systems by rendering inappropriately leased storage compartments unavailable to actual attendees of an event, but also results in lost revenue from the offending users, who would otherwise be expected to lease storage compartments from other standard, non-ride storage systems.

### SUMMARY OF THE INVENTION

Embodiments of the present invention provide a storage system that addresses these and other disadvantages of the prior art. The system employs sensors positioned at appropriate locations throughout a venue. The sensors detect one or more triggers and/or characteristics associated with the environment of the venue, an event at the venue, date, time and/or user's interaction with the venue and communicate sensor signals to the system indicative of the sensed triggers and/or characteristics. The storage system then modifies one or more parameters of a storage compartment lease (such as duration and cost of a lease) based on the sensor signals. Triggers and/or characteristics may include, for example, location of a user of the storage system, weather conditions, the beginning of an associated event, the end of an associated event, the current time of day, the date, and/or any other detectable and/or quantifiable attribute, feature or aspect relevant to the venue or to the storage system.

Embodiments of the present invention are particularly useful with respect to limited-access storage systems, such as ride storage systems assigned to a particular event. By monitoring the beginning and end of an associated event, for example, lease durations may be modified automatically and continuously to better approximate the duration of the event, thereby reducing (or eliminating) the need for manual monitoring and adjustment of lease durations. Monitoring of a user's location throughout the venue may also permit various embodiments of the present invention to determine whether the user is abusing a limited access storage system associated with a particular event, such as when the user is detected at a location far from or inconsistent with participation in the event, and to take appropriate action, such as to terminate, reduce the duration of, and/or increase the cost of a lease.

Embodiments of the present invention may be employed with respect to any leasable item or service, such as, for example, fully automated electronic storage systems and manually monitored storage facilities (such as storage rooms, cubies, etc.), in which case various sensors positioned throughout a venue communicate sensor signals to a computer monitor or other device (e.g., smartphone, tablet, laptop, server, etc.) operated by venue staff, who then modify lease parameters manually based on the sensor signals communicated thereto.

In accordance with one embodiment of the present invention, a storage system operable by a user at a venue is provided. The system includes a plurality of securable units within the housing; a processing device, the processing device being configured to assign a securable unit to the user in accordance with a lease of the assigned securable unit and to provide the user with access credentials for accessing the assigned securable unit, the processing device being configured to initially assign at least one lease parameter to the lease; and a sensor configured to (i) sense at least one trigger or characteristic after the initial lease parameter is initially assigned to the lease and (ii) communicate a sensor signal to the processing device indicative of the sensed trigger or characteristic; in which the processing device is configured to modify the at least one lease parameter in accordance with the at least one trigger or characteristic sensed by the sensor.

In accordance with another embodiment of the present invention, the processing device is positioned within at least one of a kiosk and an administrative computer server.

In accordance with still another embodiment of the present invention, the at least one trigger or characteristic includes a location of the user.

In accordance with yet another embodiment of the present invention, the at least one lease parameter includes a duration of the lease.

In accordance with still another embodiment of the present invention, the processing device is configured to modify the duration of the lease in accordance with the location of a user.

In accordance with yet another embodiment of the present invention, the processing device is operable to reduce the duration of the lease based on the location of the user.

In accordance with still another embodiment of the present invention, the location of the user is not proximate to an associated event.

In accordance with yet another embodiment of the present invention, the location of the user is not within a queue for an associated event.

In accordance with still another embodiment of the present invention, the location of the user is not detected at an entrance or exit checkpoint of an associated event.

In accordance with yet another embodiment of the present invention, the at least one lease parameter includes a cost of the lease.

In accordance with still another embodiment of the present invention, the processing device is configured to modify the cost of the lease in accordance with the location of a user.

In accordance with yet another embodiment of the present invention, the processing device is operable to increase the cost of the lease based on the location of the user.

In accordance with yet another embodiment of the present invention, the at least one trigger or characteristic includes an end-of-event trigger or characteristic indicative of the end of an associated event.

In accordance with still another embodiment of the present invention, the processing device is configured to modify the at least one lease parameter in accordance with a series of triggers or characteristics sensed by the sensor.

In accordance with yet another embodiment of the present invention, the triggers or characteristics include a location of the user, the processing device being configured to modify the at least one lease parameter if the location of the user is detected first at the exit to an event and then at a sanctioned location.

In accordance with still another embodiment of the present invention, the sanctioned location is a vendor booth.

In accordance with yet another embodiment of the present invention, the vendor booth is a booth for purchasing photographs.

In accordance with still another embodiment of the present invention, the trigger or characteristic includes at least one of an environmental characteristic, a date, and a time.

In accordance with yet another embodiment of the present invention, a storage system operable by a user at a venue is provided. The system includes a plurality of securable units; a processing device, the processing device being configured to assign a securable unit to the user in accordance with a lease of the assigned securable unit and to provide the user with access credentials for accessing the assigned securable unit, the processing device being configured to initially assign at least one lease parameter to the lease; and a sensor configured to (i) sense at least one trigger or characteristic after the initial lease parameter is initially assigned to the lease and (ii) communicate a sensor signal to the processing device indicative of the sensed trigger or characteristic; in which the processing device is configured to present an advertisement or reward to the user in accordance with the at least one trigger or characteristic sensed by the sensor.

In accordance with still another embodiment of the present invention, the reward is a coupon.

In accordance with yet another embodiment of the present invention, the advertisement or reward is presented on a screen in proximity to a location of the user.

In accordance with still another embodiment of the present invention, the advertisement or reward is presented to the user via a user interface panel.

In accordance with yet another embodiment of the present invention, the advertisement or reward is presented to the user via a smart device.

In accordance with still another embodiment of the present invention, the at least one trigger or characteristic includes a location of the user.

In accordance with yet another embodiment of the present invention, the processing device is configured to present the advertisement or reward to the user if the location of the user is consistent with attendance at an associated event.

In accordance with still another embodiment of the present invention, the processing device is operable to regulate the at least one lease parameter by continually modifying the at least one lease parameter in accordance with the at least one trigger or characteristic sensed by the sensor, the at least one trigger or characteristic changing over time.

In accordance with yet another embodiment of the present invention, a method of regulating at least one lease parameter is provided. The method comprises the steps of assigning a securable unit to a user in accordance with a lease of the securable unit; providing the user with access credentials for accessing the securable unit; initially assigning the at least one lease parameter to the lease; sensing at least one trigger or characteristic after the at least one lease parameter is initially assigned to the lease; communicating a sensor signal indicative of the at least one trigger or characteristic; and modifying the at least one lease parameter in accordance with the at least one trigger or characteristic.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1 is an illustration of an electronic storage system in accordance with the present invention.

FIG. 2 is a diagram showing connectivity among various components of an electronic storage system in accordance with the present invention.

FIG. 3a is an illustration of a kiosk in accordance with the present invention.

FIG. 3b is a diagram showing connectivity among various components of a kiosk in accordance with the present invention.

FIG. 4a is an illustration of a user portal in accordance with the present invention.

FIG. 4b is a diagram showing connectivity among various components of a user portal in accordance with the present invention.

FIG. 5 is an illustration of a storage compartment in accordance with the present invention.

FIG. 6 is a flow diagram detailing a process for leasing a storage compartment in accordance with the present invention.

FIG. 7 is a display showing compartment size options in accordance with the present invention.

FIG. 8 is a display showing vertical location options for compartments in accordance with the present invention.

FIG. 9 is a flow diagram detailing a process for transferring a storage compartment lease in accordance with the present invention.

FIG. 10 is a flow diagram detailing a process for accessing and ending a lease of an assigned storage compartment in accordance with the present invention.

FIG. 11 is an illustration of another storage compartment in accordance with the present invention.

FIG. 12 is a flow diagram detailing a process for leasing a storage compartment from a limited-access storage system, in accordance with the present invention.

FIG. 13 is a display showing compartment size options in accordance with the present invention.

FIG. 14 is a display showing vertical location options for compartments in accordance with the present invention.

FIG. 15 is a flow diagram detailing a process for accessing and ending a lease of an assigned storage compartment of a limited-access storage system, in accordance with the present invention.

### DETAILED DESCRIPTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Furthermore, the subject application references certain processes which are presented as series of ordered steps. It should be understood that the steps described with respect to those processes are not to be understood as enumerated consecutive lists but could be performed in various orders while still embodying the invention described herein.

Where a term is provided in the singular, the plural is also contemplated and should be understood. As used in this specification and in the appended claims, the singular forms “a”, “an” and “the” include plural references unless the context clearly dictates otherwise

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

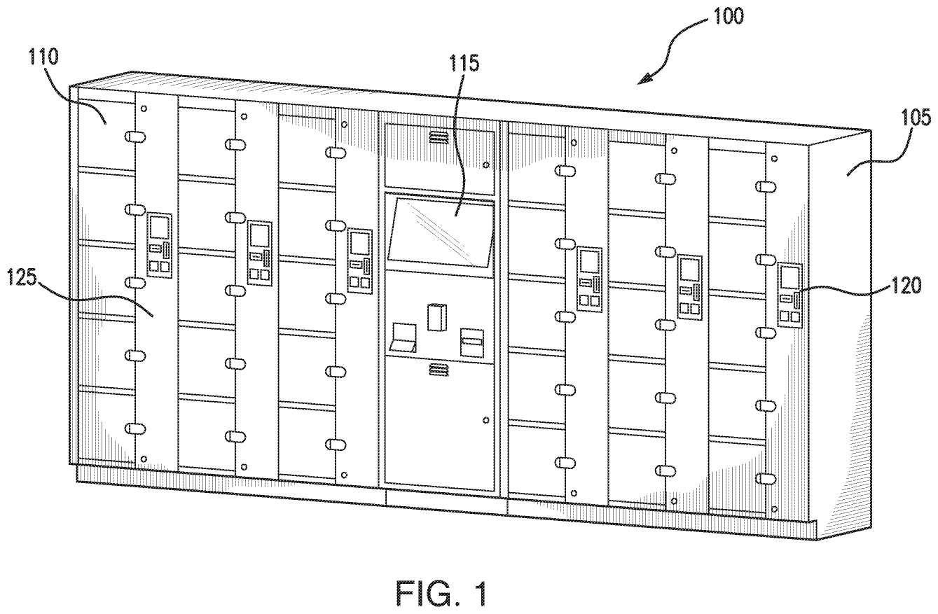

Referring now to FIG. 1, there is seen an electronic storage system 100 according to the present invention. Electronic storage system 100 includes a system housing 105, a plurality of securable units 110, such as storage compartments 110, arranged in a matrix-like configuration of multiple columns, a kiosk 115 in electronic communication with storage compartments 110, and one or more user portals 120 disposed on rails 125 between the columns of storage compartments 110. Electronic storage system 100 is intended for use by customers at various entertainment and other venues, such as amusement parks, concert halls, water parks, theaters, ski resorts and other venues where securable storage of customer property is desired. The system achieves this by enabling a customer to lease a storage compartment 110 for storage of personal belongings using kiosk 115 and/or user portals 120 and thereafter to controllably access the storage compartment 110 using kiosk 115 and/or one or more of user portals 120. The lease of storage compartment 110 may be effectuated via a rental process requiring payment or, alternatively, may be provided via other means, such as, for example, when electronic storage system 100 is configured as a limited-access storage system 100. In such a case, limited-access storage system 100 may lease a storage compartment 110 for a set duration free of charge or at a reduced rate, such as when limited-access storage system 100 is configured as a “ride” storage system 100 operable to lease a storage compartment 110 to a user free of charge for the duration of a ride or other event.

Although embodiments described herein include securable units 110 in the form of electronically controlled storage compartments 110, it will be appreciated by those of skill in the art that securable units 110 may comprise other types of storage compartments, such as cubbies, rooms or other securable areas. It will also be appreciated that securable units 110 may include other devices or features capable of being secured and/or assigned controllable access, such as, for example, strollers, shopping carts, appliances, rental equipment (such as surf boards and other recreational equipment), vending machines, etc. It will also be appreciated that various embodiments of the present invention may extend to electronic storage and other systems that do not include kiosk 115 and/or user portals 120, such as those in which leases of storage compartments 110 are managed and controlled manually via personnel or by other means.

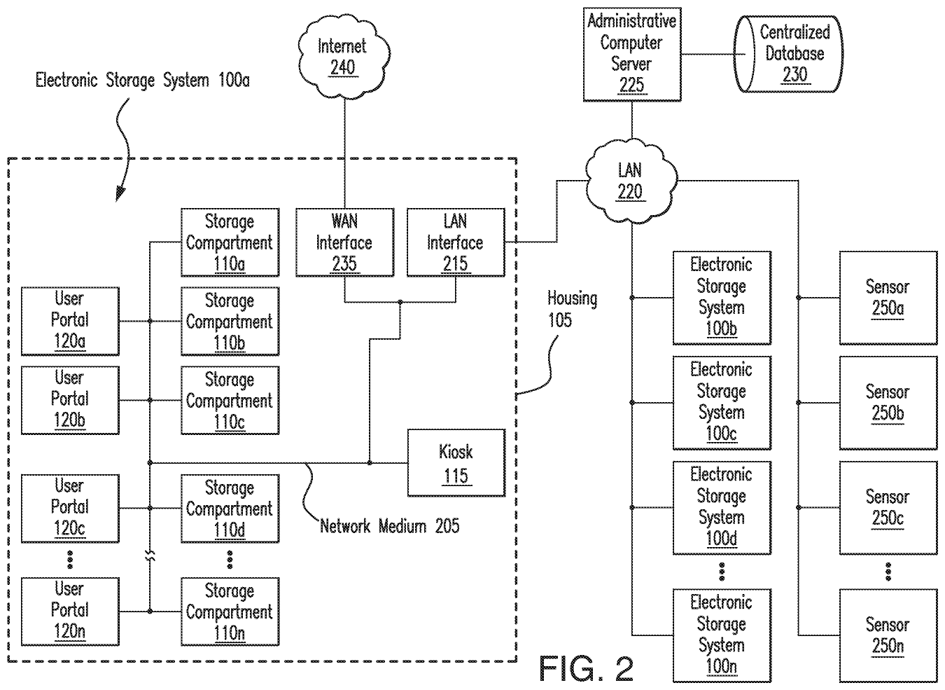

Referring now to FIG. 2, there is seen a diagram showing connectivity among various components of electronic storage system 100a in accordance with the present invention. As shown in FIG. 2, kiosk 115 communicates with user portals 120a, 120b, 120c, . . . 120n via network medium 205. Network medium 205 may include any communication medium operable to permit electronic communications between kiosk 115 and user portals 120a, 120b, 120c, . . . 120n, such as, for example, a wired Ethernet network, a wireless communication network (such as Wi-Fi or Bluetooth), direct conduit wiring, satellite, and/or any combination of these or other communication mediums. Kiosk 115 also communicates with storage compartments 110a, 110b, 110c, 110d, . . . 110n via network medium 205 (as shown in FIG. 2) or via a separate communication medium, such as by direct conduit wiring connections between kiosk 115 and storage compartments 110a, 110b, 110c, 110d, . . . 110n.

Electronic storage system 100a also includes a Local Area Network (LAN) interface 215 for connecting to a Local Area Network (LAN) 220. Local Area Network (LAN) 220 permits multiple electronic storage systems 100a, 100b, 100c, 100d, . . . 100n to be networked together, for example, when multiple electronic storage systems 100a, 100b, 100c, 100d, . . . 100n are installed at different locations throughout a venue. Similar to network medium 205, local Area Network (LAN) 220 may include any communication medium operable to permit electronic communications between systems 100a, 100b, 100c, 100d, . . . 100n. An administrative computer server 225 and associated centralized database 230 are also connected to Local Area Network (LAN) 220 for permitting centralized control of administrative functions and for managing lease transfers or “floating leases” among electronic storage systems 100a, 100b, 100c, 100d, . . . 100n, as more full described below.

local Area Network (LAN) 220 also permits electronic storage systems 100a, 100b, 100c, 100d, . . . 100n to communicate with one or more sensors 250a, 250b, 250c, . . . 250n (referred to individually and generally as sensor 250) positioned throughout the venue. Each sensor 250a, 250b, 250c, . . . 250n (referred to individually and generally as sensor 250) is configured to sense at least one trigger or characteristic associated with the venue, and event and/or a user of an electronic storage system 100a, 100b, 100c, 100d, . . . 100n (e.g., electronic storage system 100a) and to communicate a sensor signal to kiosk 115, administrative computer server 225 or other device indicative of the sensed trigger or characteristic. In some embodiments, kiosk 115 (or administrative computer server 225 or other processing device situated within or outside of an electronic storage system 100) is operable to modify a parameter of the user's lease of one or more storage compartments 110 in accordance with the sensor signal and, more particularly, in accordance with the trigger or characteristic sensed by sensor 250, in a manner more fully described below.

Electronic storage system 100a also includes a Wide Area Network (WAN) interface 235 for connecting to a Wide Area Network (WAN) 240, such as the Internet. Connectivity to the Internet permits authorized personnel (such as administrative and maintenance personnel) to access administrative and other functions of electronic storage system 100a remotely. In one embodiment, Internet connectivity also permits customers to lease one or more storage compartments 110a, 110b, 110c, 110d, . . . 110n remotely using a suitably designed software application resident on a personal computer or smart device, such as a smartphone or tablet. It will be appreciated by those skilled in the art that Local Area Network (LAN) interface 215 and Wide Area Network (WAN) interface 235 may reside within housing 105 of electronic storage system 100a (as shown in FIG. 2) or, alternatively, may reside elsewhere, for example, within kiosk 115.

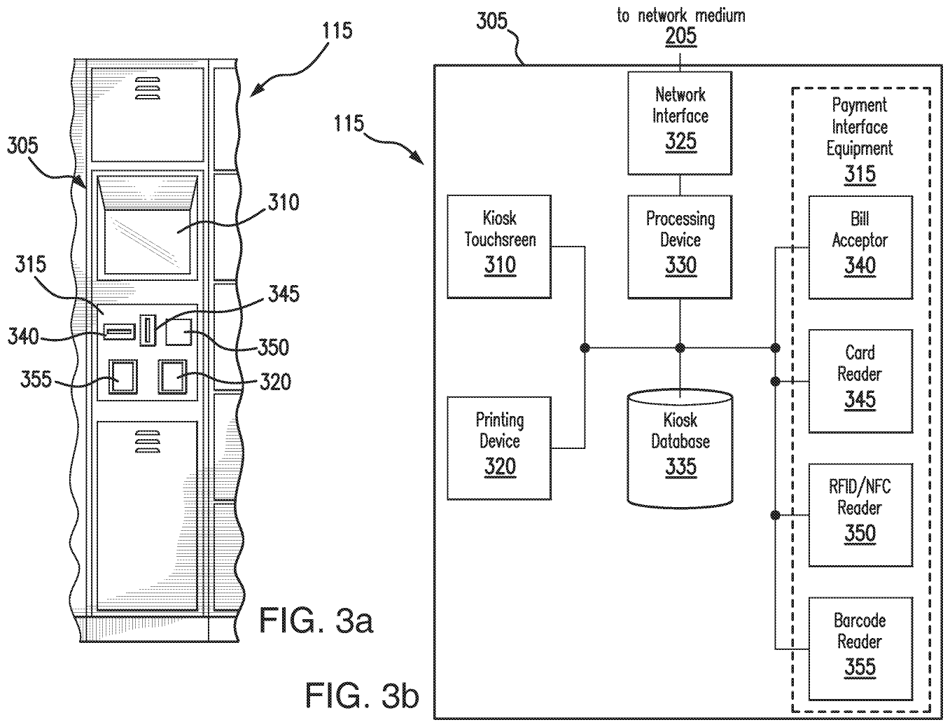

Referring now to FIGS. 3a and 3b, there is seen a kiosk 115 in accordance with the present invention. Kiosk 115 is operable to permit authorized users (including customers and administrative personnel) to lease one or more storage compartments 110, transfer or “float” a lease among multiple electronic storage systems 100, and perform various administrative functions.

Administrative functions include, for example, functions that permit administrators to generate (and email to authorized individuals) various reports, such as sales records, usage reports, and error reports. These functions also permit administrators, among other things, to execute various hardware and software tests, unlock and open one or more storage compartments 110, change the personal identification code associated with one or more storage compartments 110, disable one or more storage compartments 110, end a compartment lease, reassign a lease to a different storage compartment 110, grant access to a storage compartment 110 free of charge, and restart the system. These administrative functions are also accessible over the LAN 220 or the Internet using a web portal.

Kiosk 115 includes a kiosk housing 305, a user interface, such as kiosk touchscreen 310, for presenting information to and receiving inputs from a user, network interface 325 (such as an Ethernet interface) for connecting kiosk 115 to network medium 205 of electronic storage system 100, processing device 330 for processing lease, access, transfer and administrative functions, and a kiosk database 335. When electronic storage system 100 is not configured as a limited-access storage system 100, kiosk 115 may also include payment interface equipment 315 for accepting various forms of payment, such as credit cards, debit cards, cash, etc. and a printing device 320 for printing paper receipts.

Processing device 330 consists of hardware and/or software operable to enable leases, access, transfer and administrative functions of electronic storage system 100. For this purpose, processing device 330 may include a general purpose computer or other off-the-shelf components executing appropriate software or, alternatively, may include special purpose hardware and/or software. In one embodiment, processing device 330 consists of a rack mounted personal computer (PC) operable to execute specially designed software for performing all kiosk functions. It will be appreciated, however, that various embodiments of the present invention are not intended to be limited to any particular processing hardware and/or software. It should also be appreciated that some or all of hardware and/or software of processing device 330 may be situated outside kiosk housing 305, such as, for example, within one or more user portals 120, within or proximal to administrative computer server 225 or elsewhere.

As described above, electronic storage system 100 may be configured to lease one or more of storage compartments 110 for payment (i.e., rental). In such a situation, payment interface equipment 315 includes components that enable kiosk 115 to accept one or more forms of payment. In one embodiment, payment interface equipment 315 includes bill acceptor 340 for accepting payment in the form of cash or other negotiable instruments, card reader 345 (which may include an EMV chip reader) for retrieving payment and related information from credit and debit cards, a Radio Frequency Identification Device (RFID)/Near Field Communication (NFC) reader 350 for retrieving payment and related information from various RFID/NFC devices, such as from a transponder embedded within a wristband provided by the venue at which electronic storage system 100 is installed or from an NFC-enabled smartphone/tablet running, e.g., Apple Pay or Android Pay, and/or barcode reader 355 for retrieving payment and other information from a barcode, such as, for example, a barcode imprinted on a wristband, receipt or other medium. Of course, it will be appreciated that some or all of these components may be provided within embodiments of electronic storage system 100 configured as limited-access storage systems 100, for example, to facilitate access to leased storage compartments 110.

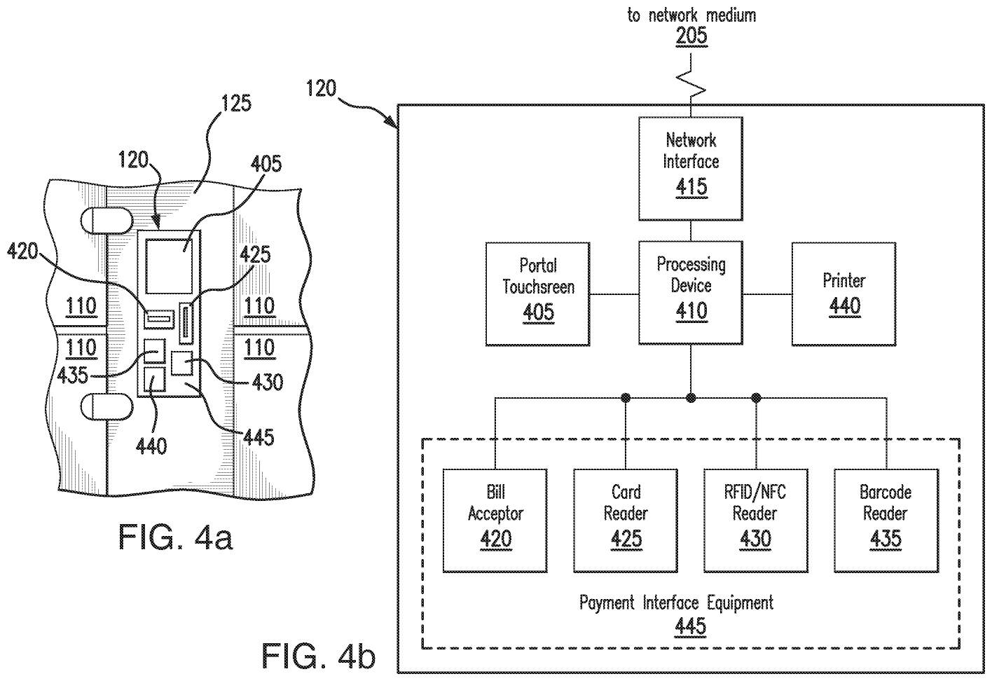

Referring now to FIGS. 4a and 4b, there is seen a user portal 120 according to the present invention. User portal 120 enables a user to access one or more storage compartments 110 leased previously. For this purpose, user portal 120 includes a portal interface, such as touchscreen 405, for presenting information to and receiving inputs from the user, a processing device 410 coupled to portal touchscreen 405 and a network interface 415 (such as an Ethernet interface) for coupling user portal 120 to network medium 205. In one embodiment, portal touchscreen 405, processing device 410 and network interface 415 may be replaced by a smart device, such as a smartphone or tablet executing a special purpose software application. In this embodiment, the smart device is installed within rail 125 and communicates with kiosk 115 wirelessly via network medium 205 or another appropriate medium.

In other embodiments, user portal 120 is operable to also perform lease functions and manage locker transfer or “floating leases” among multiple electronic storage systems 100, similar to kiosk 115. For this purpose, user portal 120 may be provided with payment interface equipment 445 and other equipment similar to that provided in kiosk 115, including bill acceptor 420, card reader 425, RFID/NFC reader 430, barcode reader 435 and/or printer 440.

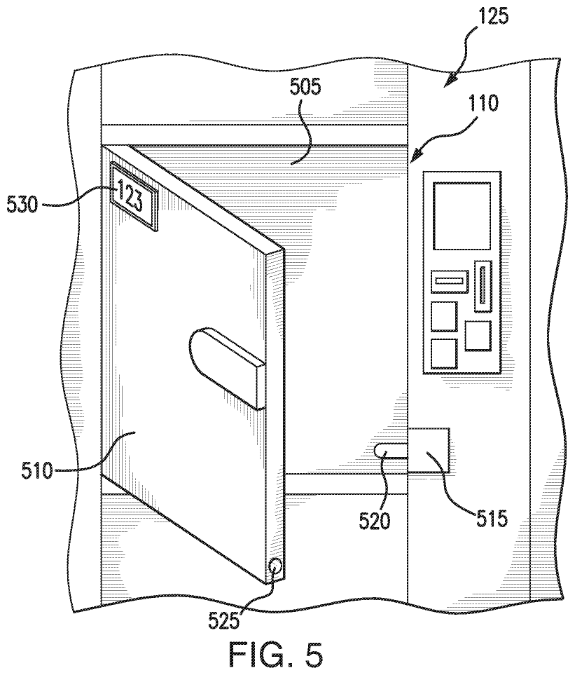

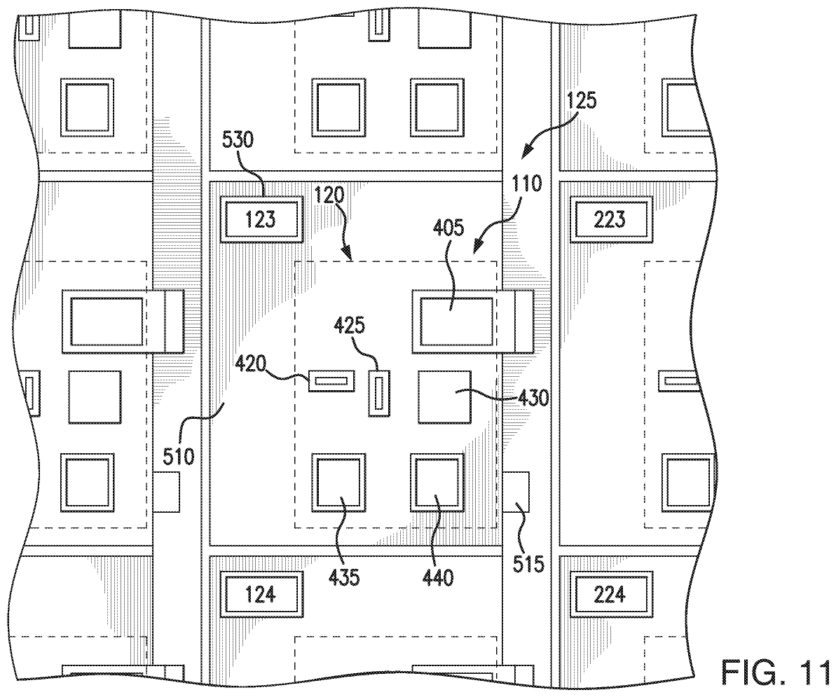

Referring now to FIG. 5, there is seen an exemplary storage compartment 110 according to the present invention. Various different sized storage compartments 110 (e.g., small, medium, large and extra-large) may be included within electronic storage system 100. Each compartment 110 includes a cubicle 505 for storing customer belongings, a door 510 for securing cubicle 505, a compartment identifier 530 (e.g., an ID number or other information uniquely identifying storage compartment 110) and an electronic locking mechanism 515 positioned within rail 125 alongside and adjacent to door 510 of cubicle 505 (in other embodiments, locking mechanism 515 is positioned on or within door 510). When door 510 is closed, locking mechanism 515 automatically secures cubicle 505 by engaging a pin 520 within an associated receptacle 525 of door 510 (or a receptacle within rail 125, in the event locking mechanism 515 is positioned on or within door 510), thereby securing door 510 firmly against rail 125 in a closed and secure position. When electronically controlled to unlock (via kiosk 115), locking mechanism 515 retracts pin 520 and opens door 510, thereby allowing access to cubicle 505. FIG. 11 illustrates an alternative embodiment of storage compartment 110 having a user portal installed thereon.

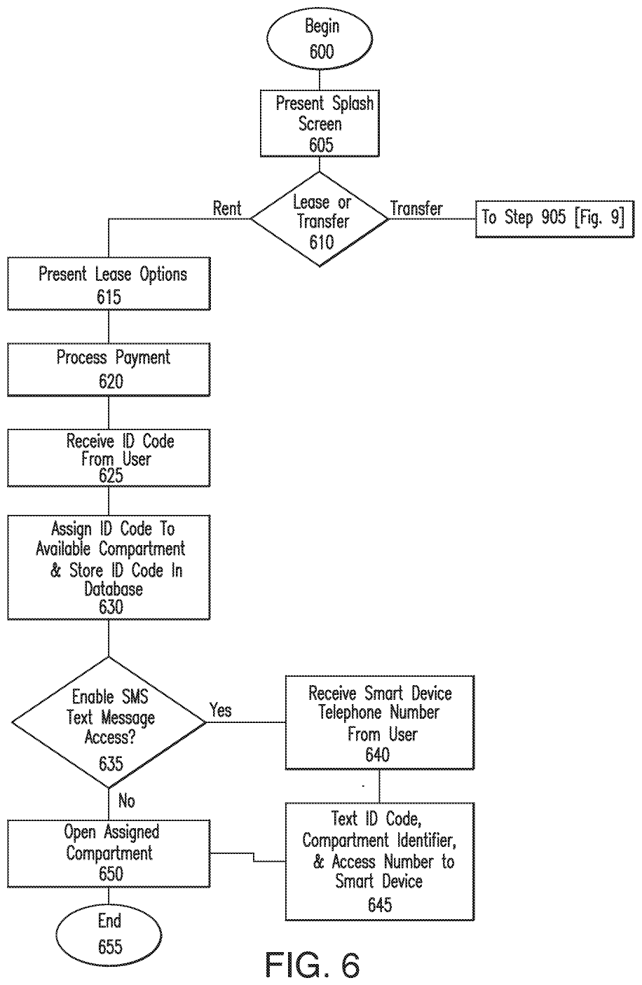

Referring now to FIG. 6, there is seen a flow chart detailing a process for leasing a storage compartment 110 for payment using kiosk 115 of electronic storage system 100. The process begins at step 600 and proceeds to step 605, where a user is presented with an introductory splash screen via touchscreen 310. The splash screen displays various information to the user, such as information relevant to the venue at which electronic storage system 100 is installed. The splash screen, or other screen presented to the user during the lease process, may also display appropriate terms and conditions, such as when electronic storage system 100 is configured as a limited-access storage system 100 operable to offer free or limited-access compartment leases for limited periods of time.

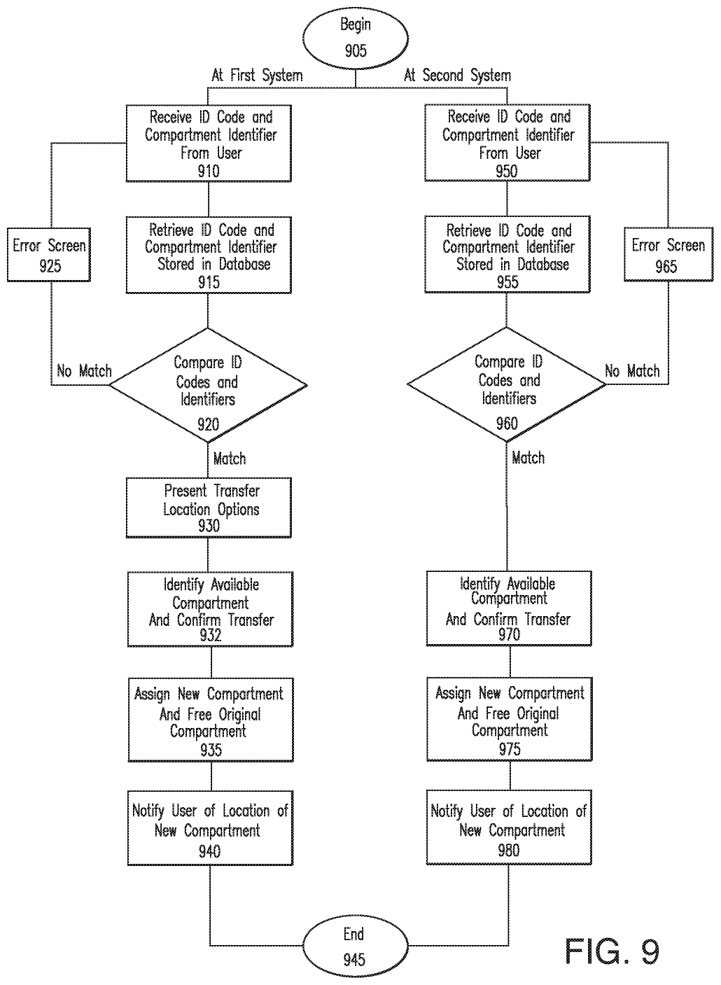

After exiting the splash screen, the user is prompted at step 610 to either lease a new storage compartment 110 for payment or transfer an existing lease to another storage compartment 110 at a different location within the venue. If the user selects the option to transfer an existing lease, the process proceeds to step 905 of FIG. 9 (described below).

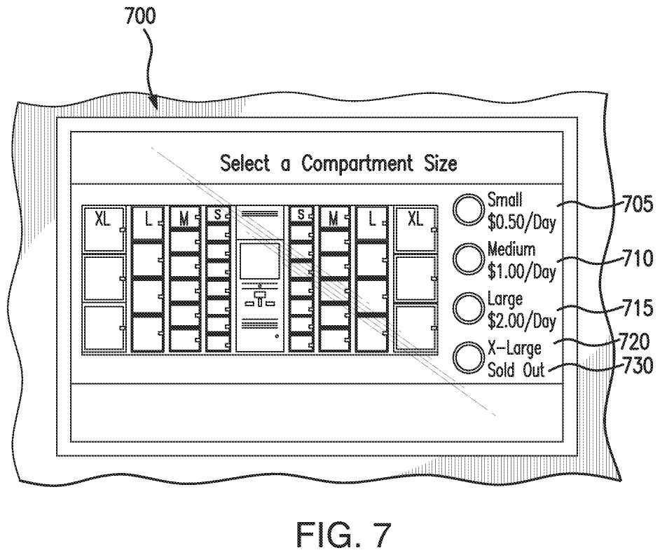

Alternatively, if the user selects the option to lease a new storage compartment 110 for payment, the process proceeds to step 615 where the user is presented with various options associated with the lease of storage compartment 110. In one embodiment, the user is presented with a display 700 on touchscreen 310 (see FIG. 7) showing options permitting him/her to select a desired size (e.g., small 705, medium 710, large 715 or extra-large 720) for a storage compartment 110 to be leased for payment. As shown in FIG. 7, size options correlate to respective prices for available compartments, whereas options for unavailable sizes are not presented or, alternatively, are presented in a non-selectable form (e.g., greyed out) with a suitable message, such as “Sold Out” message 730. Size options provide flexibility by permitting the user to select an amount of storage commensurate with his/her needs at a particular time. For example, an individual wishing to store only one or a few items may select a small compartment, whereas a larger compartment may be selected to accommodate bulky items or belongings of multiple individuals.

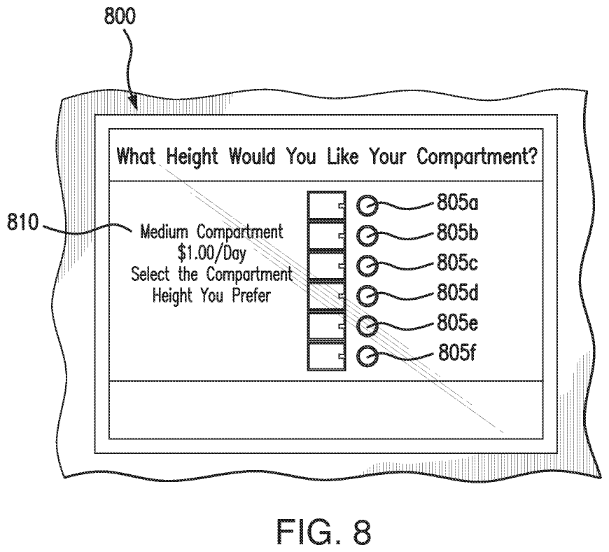

In another embodiment, the user is also presented with a display 800 (see FIG. 8) showing options 805a, 805b, 805c, . . . 805f permitting him/her to select a desired vertical location (or height) of storage compartment 110, if available. Height options 805a, 805b, 805c, . . . 805f are presented in accordance with the compartment size option 810 selected by the user (e.g., medium 710). In this manner, the user can ensure comfortable access of the assigned storage compartment 110 based on preferences and attributes, such as the height of the user, physical disabilities, etc. The user may also be presented with options permitting him/her to select the duration of the lease and/or to select a fixed price, to which the electronic storage system 100 assigns a lease duration. For example, in one embodiment, the user is presented with options permitting him/her to select a number of hours to lease storage compartment 110 or a multi-day lease, whereby the user can select a number of days to lease storage compartment 110.

After selecting various options associated with the lease, the process proceeds to step 620 where the user is presented with payment options for leasing storage compartment 110. As described above, kiosk 115 of electronic storage system 100 is configured to accept various forms of payment, such as cash, credit cards, debit cards, and payments via RFID/NFC devices and barcodes (some embodiments may omit one or multiple forms of payment or offer locker access free of charge). In the event the user pays with a credit or debit card or RFID/NFC device, kiosk 115 processes and verifies payment over the Internet (via network interface 325, network medium 205 and WAN interface 235) using standard processing communications with appropriate clearing houses.

After or during payment verification, the user is prompted at step 625 to input and verify access credentials for accessing the assigned storage compartment 110 during the lease period. In one embodiment, the access credentials include a personal identification code (such as a 4-digit identification code or alphanumeric password). For security, mask characters, such as “XXXX” or “****”, may hide the identification code from view upon entry. In an alternative embodiment, identification codes are randomly generated by kiosk 115. In yet another embodiment identification codes are replaced by codes scanned from a wristband or from and RFID and/or NFC device provided to the user.

After the user inputs and verifies his/her personal identification code, the process proceeds to step 630. At this step, kiosk 115 assigns the personal identification code to an available storage compartment 110 consistent with the size and height preferences selected by the user. Kiosk 115 then stores in kiosk database 335 the personal identification code and compartment identifier 530 associated with the assigned storage compartment 110. In an alternative embodiment, such as an embodiment permitting compartment lease transfers or “floating leases,” the personal identification code and compartment identifier 530 are stored in centralized database 230 associated with administrative computer server 225 (see FIG. 2). For this purpose, kiosk 115 transmits the personal identification code and compartment identifier 530 to administrative computer server 225 via network interface 325, network medium 205 and LAN interface 215.

After the personal identification code and compartment identifier 530 are stored in kiosk database 335 (or centralized database 230), the process proceeds to step 635, where the user is provided with an option to enable text or SMS messaging functionality for compartment access. This option allows a user to access an assigned storage compartment 110 by texting or SMS messaging his/her personal identification code and compartment identifier 530 from a smart device, such as a smartphone or tablet, to a telephone number assigned to electronic storage system 100.

If the user opts not to enable text or SMS messaging functionality, the process proceeds to step 650. Alternatively, if the user elects to enable text or SMS messaging, the process proceeds to step 640, where kiosk 115 prompts the user to enter a telephone number of a smart device (e.g., a smartphone or tablet). After the telephone number is entered, kiosk 115 “registers” the telephone number by correlating it to compartment identifier 530 associated with the assigned storage compartment 110 and storing it in kiosk database 335 or centralized database 230.

The process then proceeds to step 645. At this step, kiosk 115 texts or messages the user's personal identification code, compartment identifier 530, and an access telephone number to the user's smart device. In one embodiment, the kiosk is also configured to re-transmit the personal identification code and compartment identifier 530 in the event the user forgets or misplaces one or both pieces of information. To initiate the retransmission, the user re-enters his/her smart device telephone number into kiosk 115 in accordance with retrieval options presented to the user via kiosk 115. If the telephone number entered by the user matches the one stored at step 640, kiosk 115 re-transmits the personal identification code and compartment identifier 530 to the user's smart device.

The text or SMS message may be sent in a conventional and well known manner via a cellular network or, alternatively, via the Internet using network interface 325, network medium 205, and WAN interface 235. In the event Internet communication is employed, the text or SMS message may be converted using any of a number of online vendors which offer Internet-to-SMS messaging capability (or vice versa) or by a software application executing, for example, on a centralized server connected to the Internet. In another embodiment, the information to be included in the text or SMS message is communicated via email to a server or other centralized computing device, which converts the email into a text or SMS message.

The process then proceeds to step 650. At this step, kiosk 115 unlocks and opens the leased storage compartment 110 by controlling the associated locking mechanism 515 of the compartment and communicates compartment identifier 530 and the lease time to the user via touchscreen 310. This information may also be provided to the user via a receipt, which may be printed via printing device 320 and/or emailed to the user.

After the lease process is completed at step 655, the user locates the assigned storage compartment 110 using compartment identifier 530 provided by kiosk 115. An indicator light (not shown) on or adjacent to door 510 of compartment 110 may provide a visual indication to aid the user in locating the leased storage compartment 110. After the user locates and places his/her personal belongings in the leased storage compartment 110, the compartment is secured by closing door 510, which automatically engages the associated locking mechanism 515 within rail 125. The user may then access the leased storage compartment 110 during the lease period by entering the personal identification code and compartment identifier 530 into kiosk 115 in accordance with a compartment access process.

In embodiments employing text or SMS messaging access, the user may access the assigned storage compartment 110 also by texting or SMS messaging his/her personal identification code and compartment identifier 530 to the access telephone number assigned to electronic storage system 100.

In an alternative embodiment, the lease process described above with respect to FIG. 6 may be performed using one or more user portals 120. In this embodiment, user preferences, such as preferences regarding locker size and vertical location, payment information, and the personal identification code are received from the user via portal touchscreen 405 and payment interface equipment 445 of a user portal 120. User portal 120 then transmits this information to kiosk 115 via network interface 415 and network medium 205. Next, kiosk 115 verifies payment, assigns the personal identification code to an available storage compartment 110, and stores the identification code and associated compartment identifier 530 in kiosk database 335 or centralized database 230. Kiosk 115 then unlocks the assigned storage compartment 110 and transmits the associated compartment identifier 530 to user portal 120, where it and other information verifying the lease are displayed to the user via portal touchscreen 405. This information may also be provided to the user via a receipt, which may be printed via portal printer 440 and/or emailed to the user.

In another embodiment, the lease process described above with respect to FIG. 6 may be performed using a smart device, computer, NFC device, or website portal executing a suitably designed application. In this embodiment, lease functions are presented to the user via the application. User inputs, such as locker size, height, credit card information, etc., are then communicated by the application to electronic storage system 100 via the Internet or other medium. In another embodiment, the user performs the lease process by communicating lease options, credit card information, etc. to electronic storage system 100 via text or SMS messaging.

In an alternative embodiment, processing for payment verification and lease functions are performed directly by user portal 120 without involvement from kiosk 115. In yet another embodiment, processing for payment verification and lease functions are performed by a remote computer, such as administrative computer server 225, which is in communication with user portal 120 (or kiosk 115 in the event kiosk 115 is used for performing the lease process).

In still other alternative embodiments, such as those that provide limited-access storage systems 100, the user may not be prompted to rent, pay for and/or transfer an existing lease, but rather may simply be assigned a storage compartment 110 for a limited time, such as, for example, for a limited time necessary for the user to attend an event or complete a task or ride.

Referring now to FIG. 9, there is seen a process for transferring a lease of a storage compartment 110 to another location in accordance with the present invention. Lease transfers may be desired in situations where a venue installs multiple electronic storage systems 100 at various different locations throughout the venue. In such a case, a user who leases a storage compartment 110 for payment at one location within a venue, but visits multiple locations throughout a visit, may be inconvenienced by having to return to the same location each time he/she wishes to access storage compartment 110. An embodiment of the present invention addresses this concern by permitting lease transfers or “floating” leases that enable a user to transfer a storage compartment lease from one electronic storage system 100 to another system 100 installed at a different location within the same venue.

A user initiates a lease transfer process from a first electronic storage system 100x to a second storage system 100y using kiosk 115 of either the first or second systems 100x, 100y. After receiving the splash screen and selecting the option to transfer an existing lease (see steps 605, 610 of FIG. 6), the locker transfer process starts at step 905.

If the user initiates the lease transfer using kiosk 115 of the first electronic storage system 100x, the process proceeds to step 910, where the user is prompted for his/her personal identification code and compartment identifier 530 associated with and displayed on the leased storage compartment 110.

The lease transfer process then proceeds to step 915, where kiosk 115 retrieves the personal identification code and compartment identifier 530 that were stored previously in the centralized database 230 and/or kiosk database 335 during a lease process, such as the lease process described with respect to FIG. 6.

The process then proceeds to step 920, where kiosk 115 compares the retrieved identification code and compartment identifier 530 with the code and identifier 530 entered by the user at step 910. If the identification codes and/or compartment identifiers 530 do not match, the process proceeds to step 925, where the user is presented with an error screen. The process then proceeds to step 910, where the user is re-prompted for his/her personal identification code and compartment identifier 530.

If the comparison of step 920 results in a match, the process proceeds to step 930, where the user is presented with a screen prompting him/her to select a location within the venue to which the lease will be transferred. Location options may be presented as a text-based list of areas within the venue or as a map of locations.

After the user selects a new location for the lease, the process proceeds to step 932. At this step, kiosk 115 communicates with administrative computer server 225 over LAN 220 to identify an available electronic storage system 100 (in this example, second electronic storage system 100y) and storage compartment 110 at the new location meeting the size and height requirements of the original lease. In another embodiment, the user is provided with the ability to reselect compartment options, such as the size and height preferences of a new storage compartment 110. Once a suitable compartment 110 is located, kiosk 115 requests the user to confirm the transfer and informs him/her that access to the originally leased storage compartment 110 will be withdrawn upon transfer.

After the user confirms the transfer, the transfer process proceeds to step 935, where administrative computer server 225, interacting with centralized database 230 and/or kiosk database 335, reassigns the user's personal identification code to new storage compartment 110 of the second electronic storage system 100y and frees the originally assigned storage compartment 110 for subsequent lease.

At step 940, kiosk 115 of the first electronic storage system 100x communicates the location of new storage compartment 110 and associated compartment identifier 530 to the user. This information may also be provided on a receipt emailed to the user and/or printed by printing device 320 of kiosk 115 upon completion of the transfer process. The transfer process then ends at step 945.

If the user initiates the lease transfer using kiosk 115 of the second electronic storage system 100y, the process proceeds from step 905 to step 950, where the user is prompted for his/her personal identification code and compartment identifier 530 associated with and displayed on the assigned storage compartment 110 of the first electronic storage system 100x.

The lease transfer process then proceeds to step 955, where kiosk 115 retrieves the personal identification code and compartment identifier 530 that were stored previously in centralized database 230 and/or kiosk database 335 of the first electronic storage system 100 during a lease process, such as the lease process described with respect to FIG. 6.

The process then proceeds to step 960, where kiosk 115 compares the retrieved identification code and compartment identifier 530 with the code and identifier 530 entered by the user at step 950. If the identification codes and/or compartment identifiers 530 do not match, the process proceeds to step 965, where the user is presented with an error screen. The process then proceeds to step 950, where the user is re-prompted for his/her personal identification code and compartment identifier 530 associated with and displayed on the originally leased storage compartment 110.

If the comparison of step 960 results in a match, the process proceeds to step 970. At this step, kiosk 115 communicates with administrative computer server 225 over LAN 220 to identify an available storage compartment 110 of the second electronic storage system 100y meeting the size and height requirements of the original lease. In another embodiment, the user is provided with the ability to reselect compartment options, such as the size and height preferences of a new storage compartment 110. Once a suitable compartment is located, kiosk 115 requests the user to confirm the transfer and informs him/her that access to the originally leased storage compartment 110 of the first electronic storage system 100x will be withdrawn upon transfer.

After the user confirms the transfer, the transfer process proceeds to step 975, where administrative computer server 225, interacting with centralized database 230 (or kiosk database 335), reassigns the user's personal identification code to new storage compartment 110 of the second electronic storage system 100y and frees the originally assigned storage compartment 110 for subsequent lease.

At step 980, kiosk 115 of the second electronic storage system 100 communicates the compartment identifier 530 associated with new storage compartment 110 to the user. This information may also be provided on a receipt emailed to the user and/or printed by printing device 320 of kiosk 115 upon completion of the transfer process. The transfer process then ends at step 945.

After the transfer process is completed, the user locates the newly leased storage compartment 110 of the second electronic storage system 100y. An indicator light (not shown) on or adjacent to the new storage compartment 110 may provide a visual indication to aid the user in locating the new storage compartment 110. After the user locates and places his/her personal belongings in the new storage compartment 110, compartment 110 is secured by closing door 510, which automatically engages the associated locking mechanism 515 within rail 125. The user may then access the new storage compartment 110 anytime during the lease period.

In an alternative embodiment, the transfer process described with respect to FIG. 9 may be performed by one or more user portals 120 of either the first or second electronic storage systems 100x, 100y. In yet another embodiment, the personal identification codes used in the lease transfer process are replaced with codes scanned from wristbands or from RFID/NFC devices assigned to the users.

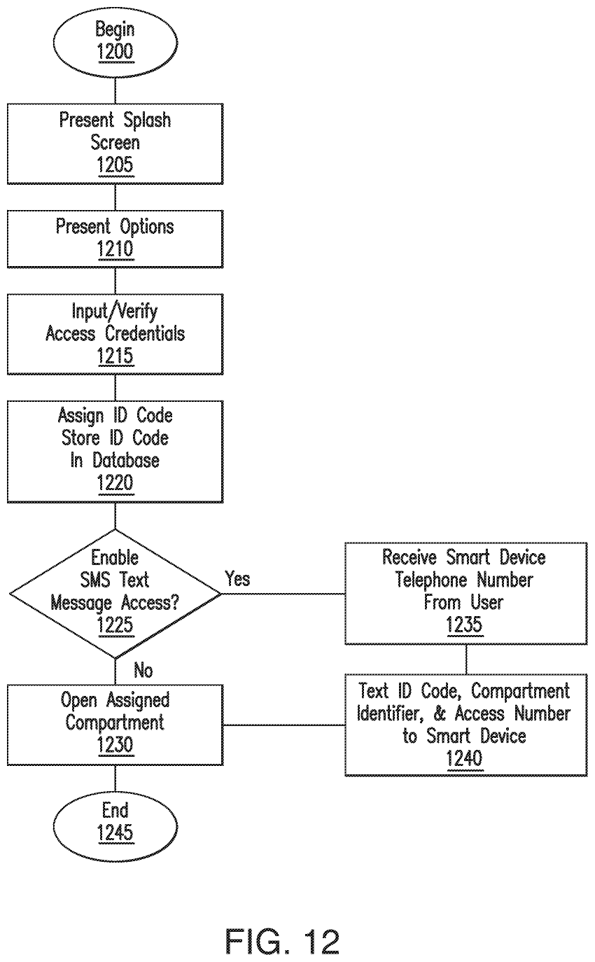

Referring now to FIG. 12, there is seen a flow chart detailing a process for using a limited-access storage system 100 to lease a storage compartment 110 to a user. Limited-access storage system 100 may be configured, for example, as a “ride” storage system 100 operable to lease a storage compartment 110 to a user at a reduced price (such as free of charge) and/or for a limited duration while he/she experiences an event at the venue, such as a ride, sporting event or concert. A ride storage system 100 advantageously encourages users to store personal items (such as smart phones, watches, tablets, etc.) for a temporary period to alleviate fear of loss or damage thereto during an event. The ride storage system 100 may also promote safety with respect to events that may cause personal items to jostle free and strike other users, such as a rollercoaster ride.

The process begins at step 1200 and proceeds to step 1205, where a user is presented with an introductory splash screen via touchscreen 310. The splash screen displays various information to the user, such as information relevant to the venue at which limited-access storage system 100 is installed. The splash screen, or other screen presented to the user during the lease process, may also display appropriate terms, such as a limited duration of the lease and other conditions that a user must agree to, such as, for example, an acknowledgement that the user will attend a certain event, such as a ride, sporting event or concert. In at least one embodiment, the duration of the lease is set equal to the approximate duration of an event plus an optional overflow duration (e.g., five to ten minutes) to provide sufficient time for the user to exit the event and make his/her way back to limited-access storage system 100 to collect his/her personal items. In another embodiment, the end of the event is detected, after which the user is provided with a set amount of time to return to limited-access storage system 100. In still another embodiment, use of limited-access storage system 100 is provided free of charge if the user operates system 100 properly and/or performs another actions, such as attending an event.

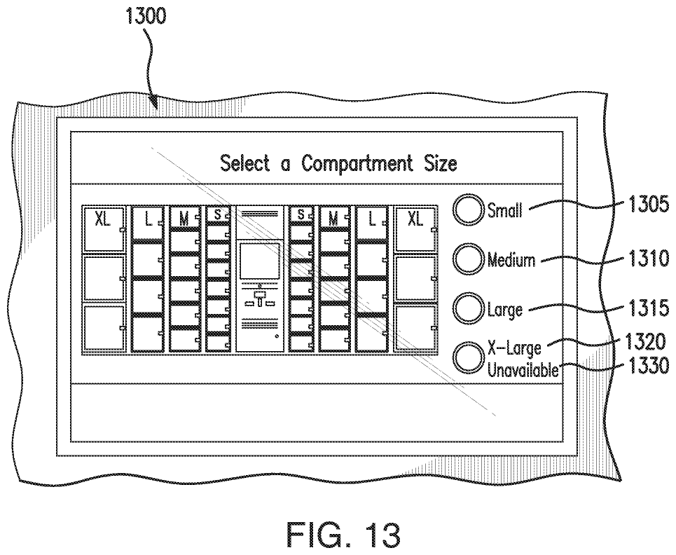

After exiting the splash screen, the process proceeds to step 1210 where the user is presented with various options associated with the lease of storage compartment 110. In one embodiment, the user is presented with a display 1300 on touchscreen 310 (see FIG. 13) showing options permitting him/her to select a desired size (e.g., small 1305, medium 1310, large 1315 or extra-large 1320) for a storage compartment 110 to be leased. Options for unavailable sizes are not presented or, alternatively, are presented in a non-selectable form (e.g., greyed out) with a suitable message, such as “Unavailable” message 1330. Size options provide flexibility by permitting the user to select an amount of storage commensurate with his/her needs during the event. For example, an individual wishing to store only one or a few items may select a small compartment, whereas a larger compartment may be selected to accommodate bulky items or belongings of multiple individuals. In alternative embodiments, size options are either not available (such as when limited-access storage system 100 includes storage compartments 110 of only a single size) or not presented to the user, in which case limited-access storage system 100 determines which size storage compartment 110 to lease to the user.

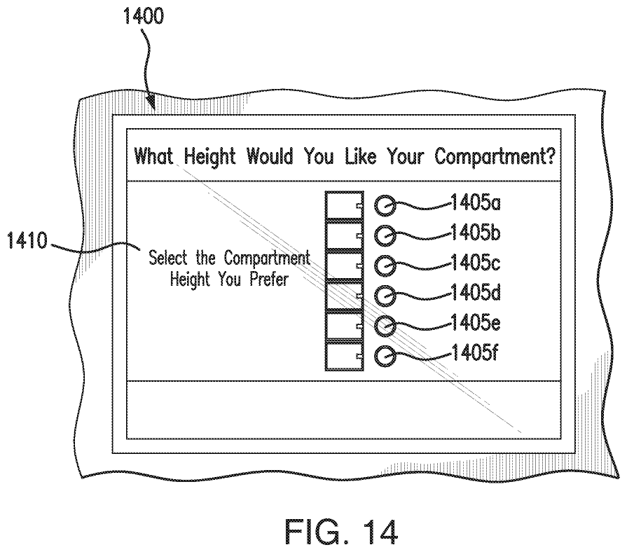

In another embodiment, the user is also presented with a display 1400 (see FIG. 14) showing options 1405a, 1405b, 1405c, . . . 1405f permitting him/her to select a desired vertical location (or height) of storage compartment 110, if available. Height options 1405a, 1405b, 1405c, . . . 1405f are presented in accordance with the compartment size option 1410 selected by the user (e.g., medium 1410). In this manner, the user can ensure comfortable access of the assigned storage compartment 110 based on preferences and attributes, such as the height of the user, physical disabilities, etc. In alternative embodiments, height options are either not available or not presented to the user, in which case limited-access storage system 100 determines the height of storage compartment 110 to lease to the user.

The process then proceeds to step 1215, at which the user is prompted to input and verify access credentials for accessing the assigned storage compartment 110 during the lease period. In one embodiment, the access credentials include a personal identification code (such as a 4-digit identification code or alphanumeric password). For security, mask characters, such as “XXXX” or “****”, may hide the identification code from view upon entry. In an alternative embodiment, identification codes are randomly generated by kiosk 115, administrative computer server 225 or other system. In yet another embodiment identification codes are replaced by codes scanned from a wristband or from and RFID and/or NFC device provided to the user.

After the user inputs and verifies his/her personal identification code, the process proceeds to step 1220. At this step, kiosk 115 assigns the personal identification code to an available storage compartment 110. Kiosk 115 then stores in kiosk database 335 the personal identification code and compartment identifier 530 associated with the assigned storage compartment 110. In alternative embodiments, the personal identification code and compartment identifier 530 are stored in the administrative computer server 225 or other system via network interface 325, network medium 205 and LAN interface 215.

After the personal identification code and compartment identifier 530 are stored in kiosk database 335 (or centralized database 230), the process proceeds to step 1225, where the user is provided with an option to enable text or SMS messaging functionality for compartment access. This option allows the user to access his/her assigned storage compartment 110 by texting or SMS messaging his/her personal identification code and compartment identifier 530 from a smart device, such as a smartphone or tablet, to a telephone number assigned to limited-access storage system 100.

If the user opts not to enable text or SMS messaging functionality, the process proceeds to step 1230. Alternatively, if the user elects to enable text or SMS messaging, the process proceeds to step 1235, where kiosk 115 prompts the user to enter a telephone number of a smart device (e.g., a smartphone or tablet). After the telephone number is entered, kiosk 115 “registers” the telephone number by correlating it to compartment identifier 530 associated with the assigned storage compartment 110 and storing it in kiosk database 335 or centralized database 230.

The process then proceeds to step 1240. At this step, kiosk 115 texts or messages the user's personal identification code, compartment identifier 530, and an access telephone number to the user's smart device. In one embodiment, the kiosk is also configured to re-transmit the personal identification code and compartment identifier 530 in the event the user forgets or misplaces one or both pieces of information. To initiate the retransmission, the user re-enters his/her smart device telephone number into kiosk 115 in accordance with retrieval options presented to the user via kiosk 115. If the telephone number entered by the user matches the one stored at step 1235, kiosk 115 re-transmits the personal identification code and compartment identifier 530 to the user's smart device.

The text or SMS message may be sent in a conventional and well known manner via a cellular network or, alternatively, via the Internet using network interface 325, network medium 205, and WAN interface 235. In the event Internet communication is employed, the text or SMS message may be converted using any of a number of online vendors which offer Internet-to-SMS messaging capability (or vice versa) or by a software application executing, for example, on a centralized server connected to the Internet. In another embodiment, the information to be included in the text or SMS message is communicated via email to a server or other centralized computing device, which converts the email into a text or SMS message.

The process then proceeds to step 1230. At this step, kiosk 115 unlocks and opens the leased storage compartment 110 by controlling the associated locking mechanism 515 of the compartment and communicates compartment identifier 530 and the lease time to the user via touchscreen 310. This information may also be provided to the user via a receipt, which may be printed via printing device 320 and/or emailed to the user.

After the lease process is completed at step 1245, the user locates the assigned storage compartment 110 using compartment identifier 530 provided by kiosk 115. An indicator light (not shown) on or adjacent to door 510 of compartment 110 may provide a visual indication to aid the user in locating the leased storage compartment 110. After the user locates and places his/her personal belongings in the leased storage compartment 110, the compartment is secured by closing door 510, which automatically engages the associated locking mechanism 515 within rail 125. The user may then access the leased storage compartment 110 during the lease period by entering the personal identification code and compartment identifier 530 into kiosk 115 in accordance with a compartment access process. In alternative embodiments, the user may access the leased storage compartment only once or a limited number of times during the lease period. In still other embodiments, access to the leased storage compartment is enabled automatically by limited-access storage system 100 at a particular time, such as, for example, at the end of an event or at the end of the lease period.

In embodiments employing text or SMS messaging access, the user may access the assigned storage compartment 110 also by texting or SMS messaging his/her personal identification code and compartment identifier 530 to the access telephone number assigned to electronic storage system 100.

While the lease process described above with respect to FIG. 12 does not require the user to tender payment for lease of storage compartment 110, it should be appreciated that payment may be required in a manner similar to that described above with respect to the lease process flow chart of FIG. 6. It should also be appreciated that “floating lease” options (i.e., options that permit the user to transfer his lease of storage compartment 110 to another full or limited-access storage system 100) may also be provided to the user.

In an alternative embodiment, the lease process described above with respect to FIG. 12 may be performed using one or more user portals 120. In this embodiment, user preferences, such as preferences regarding locker size and vertical location, payment information (if any), and the personal identification code are received from the user via portal touchscreen 405 and payment interface equipment 445 of a user portal 120. User portal 120 then transmits this information to kiosk 115 via network interface 415 and network medium 205. Next, kiosk 115 verifies payment (if any), assigns the personal identification code to an available storage compartment 110, and stores the identification code and associated compartment identifier 530 in kiosk database 335 or centralized database 230. Kiosk 115 then unlocks the assigned storage compartment 110 and transmits the associated compartment identifier 530 to user portal 120, where it and other information verifying the lease are displayed to the user via portal touchscreen 405. This information may also be provided to the user via a receipt, which may be printed via portal printer 440 and/or emailed to the user.

In another embodiment, the lease process described above with respect to FIG. 12 may be performed using a smart device, computer, NFC device, or website portal executing a suitably designed application. In this embodiment, lease functions are presented to the user via the application. User inputs, such as locker size, height, etc., are then communicated by the application to electronic storage system 100 via the Internet or other medium. In other embodiments, the user performs the lease process by communicating lease options, credit card information (if any), etc. to limited-access storage system 100 via text or SMS messaging.

In an alternative embodiment, processing for payment verification and lease functions are performed directly by user portal 120 without involvement from kiosk 115. In yet another embodiment, processing for payment verification and lease functions are performed by a remote computer, such as administrative computer server 225, which is in communication with user portal 120 (or kiosk 115 in the event kiosk 115 is used for performing the lease process).

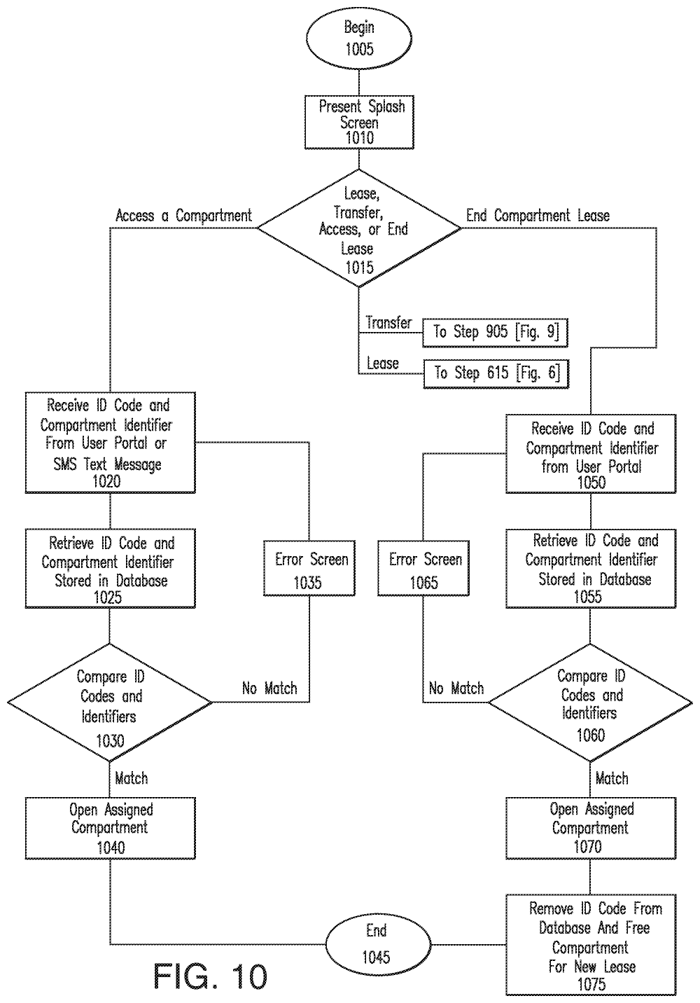

Referring now to FIG. 10, there is seen a process for accessing and ending a lease of an assigned storage compartment 110 using one or more user portals 120. The process beings at step 1005 and proceeds to step 1010, where the user is presented with a splash screen similar to or different than the one presented to the user at step 605 of the lease process. After exiting the splash screen, the process proceeds to step 1015, where the user is presented with options to (i) lease a storage compartment 110 for payment; (ii) transfer a leased storage compartment 110 to another location; (iii) access/continue a leased storage compartment 110; or (iv) end a lease. With respect to embodiments that provide a limited-access storage system 100, the user may be presented, for example, only with options to access a previously assigned storage compartment.

If the user selects the option to lease a storage compartment for payment, the process proceeds to step 615 of FIG. 6 where the user is presented with various options associated with the lease of a storage compartment 110. If the user selects the option to transfer a lease, the process proceeds to step 905 of FIG. 9, where the user is prompted to initiate a lease transfer.

If the user selects the option to access a leased storage compartment 110, the process proceeds to step 1020, where the user is prompted via portal touchscreen 405, to enter the compartment identifier 530 and personal identification number associated with the leased storage compartment 110. This information is then transmitted by user portal 120 to kiosk 115 via network interface 415 and network medium 205.

In an alternative embodiment, the user may access a storage compartment 110 using a credit card reader installed on door 510 of a lease compartment 110 (such as card reader 425 of user portal 120 with respect to embodiments having user portals 120 installed on individual doors 510 of storage compartments 110). In this embodiment, the user's credit card information is first stored in kiosk 115 during a lease process and correlated to the leased storage compartment 110. The user then accesses the leased storage compartment 110 by swiping or inserting his/her credit card into the credit card reader on the lease compartment 110. The credit card information retrieved by the card reader is then transmitted to kiosk 115 and compared to the credit card information stored during the lease process. In the event of a match, kiosk 115 unlocks and permits access to the leased storage compartment 110. Of course, this option for accessing the leased storage compartment 110 may not be available with respect to embodiments that provide a limited-access storage system 100.

In an alternative embodiment, the user may utilize a smart device, such as a smart phone or tablet, to text or SMS message the compartment identifier 530 and personal identification number to an access telephone number assigned to electronic storage system 100 and transmitted to the user's smart device during a compartment lease process, such as the lease process described with respect to FIG. 6. In this embodiment, kiosk 115 receives the text or SMS message from a conventional cellular network or, alternatively, via the Internet using network interface 325, network medium 205, and WAN interface 235. In the event Internet communication is employed, the text or SMS message may be converted using any of a number of online vendors which offer Internet-to-SMS messaging capability (and vice versa) or by a software application executing, for example, on a centralized server connected to the Internet.

In still another embodiment, kiosk 115 retrieves the smart device's telephone number from a conventional caller-ID signal transmitted with the text or SMS message. The retrieved telephone number is compared with the smart device telephone number correlated with compartment identifier 530 and stored in kiosk database 335 or centralized database 230 during a compartment lease process, such as the lease process described with respect to FIG. 6. If the telephone numbers do not match, kiosk 115 disregards the text or SMS message. This embodiment provides additional security by requiring that a text or SMS message for accessing an leased storage compartment 110 be transmitted from the smart device telephone number registered with kiosk 115 during the lease process.

In yet another embodiment, the user need only text or SMS message the personal identification code. In this embodiment, kiosk 115 uses the smart device's telephone number retrieved from caller-ID to lookup the compartment identifier 530 associated with the leased storage compartment 110.

The process then proceeds to step 1025, where kiosk 115 retrieves the personal identification code and compartment identifier 530 that were stored previously in centralized database 230 and/or kiosk database 335 during the lease process.

The process then proceeds to step 1030, where kiosk 115 compares the retrieved identification code and compartment identifier 530 with the code and identifier 530 entered by the user at step 1020. If the identification codes and/or compartment identifiers 530 do not match, the process proceeds to step 1035, where kiosk 115 transmits information indicative of the mismatch to user portal 120, which may then present the user with an error message (such as “Incorrect Code” or other suitable message) via portal touchscreen 405. The process then proceeds to step 1020, where the user is re-prompted for his/her personal identification code and compartment identifier 530.

If the codes match, the process proceeds to step 1040. At this step, kiosk 115 communicates information indicative of the match to user portal 120, which may then present the user with a message such as “success” or other suitable message informing the user that a match has occurred. In the event of a match, kiosk 115 also transmits an unlock signal to the locking mechanism 515 associated with the assigned storage compartment 110, thereby causing door 510 of the leased storage compartment 110 to unlock and open automatically to permit access thereto. The process then ends at step 1045.

After the access process is completed, the user locates the leased storage compartment 110 using compartment identifier 530. An indicator light (not shown) on or adjacent to door 510 of compartment 110 may provide a visual indication to aid the user in locating the leased storage compartment 110. After the user locates and places his/her personal belongings in the leased storage compartment 110, the compartment is secured by closing door 510, which automatically engages the associated locking mechanism 515 within rail 125.

If the user selects the option to end a lease at step 1015, the process proceeds to step 1050. At this step, the user is prompted via portal touchscreen 405 to enter the compartment identifier 530 and personal identification number associated with the leased storage compartment 110. This information is then transmitted by user portal 120 to kiosk 115 via network interface 415 and network medium 205.

The process then proceeds to step 1055, where kiosk 115 retrieves the personal identification code and compartment identifier 530 that were stored previously in centralized database 230 and/or kiosk database 335 during the lease process.

The process then proceeds to step 1060, where kiosk 115 compares the retrieved identification code and compartment identifier 530 with the code and identifier 530 entered by the user at step 1050. If the identification codes and/or compartment identifiers 530 do not match, the process proceeds to step 1065, where kiosk 115 transmits information indicative of the mismatch to user portal 120, which may then present the user with an error message (such as “Incorrect Code” or other suitable message) via portal touchscreen 405. The process then proceeds to step 1050, where the user is re-prompted for his/her personal identification code and compartment identifier 530.

If the codes match, the end lease process proceeds to step 1070. At this step, kiosk 115 communicates information indicative of the match to user portal 120, which may then present the user with a message such as “success” or other suitable message informing the user that a match has occurred. In the event of a match, kiosk 115 also transmits an unlock signal to the locking mechanism 515 associated with the leased storage compartment 110, thereby causing door 510 of the leased storage compartment 110 to unlock and open automatically to permit access thereto.

At step 1075, kiosk 115 removes from centralized database 230 and/or kiosk database 335 the stored personal identification code associated with the leased storage compartment 110 and frees the storage compartment 110 for subsequent lease. The user is then free to access storage compartment 110 one last time to remove his/her personal belongings, after which (i.e., upon closing door 510 of compartment 110) he/she is no longer permitted access to storage compartment 110. The process then ends at step 1045.

In an alternative embodiment, each user portal 120 is operable to permit access only to a subset of storage compartments, such as, for example, only storage compartments 110 in a column immediately adjacent to the user portal 120. This embodiment advantageously reduces queuing at user portals 120 by effectively splitting the user group into smaller subsets, each of which is required to use only a specific user portal 120 for accessing assigned storage compartments 110. Queuing may be reduced even further by ensuring that a lease process, such as the lease process described with respect to FIG. 6, more evenly distributes successive leases of storage compartments 110 among different user portals 120. For example, in an embodiment where each user portal 120 permits access only to storage compartments 110 in a column immediately adjacent the user portal 120, a lease process may advantageously assign storage compartments 110 in such as a way so as to better ensure that storage compartments 110 are distributed more evenly among columns.

With respect to embodiments employing a user portal 120 on each door 510 of storage compartment 110, each portal 120 may be configured to perform lease functions (such as those described with respect to FIGS. 6 and 10) with respect to any storage compartment 110 of electronic storage system 100. In another embodiment, each door mounted user portal 120 is configured to perform lease functions only with respect to the storage compartment 110 on which it is installed.

With respect to embodiments that provide a limited-access storage system 100, the user may be required to access his/her leased storage compartment 110 within a limited amount of time and/or may be provided only with the ability to access the leased storage compartment 110 a limited number of times, such as, for example, only once. The limited-access storage system 100 may also end the lease of storage compartment 110 automatically after a set period of time or upon the detection of a specified trigger event or characteristic, as more fully described below.

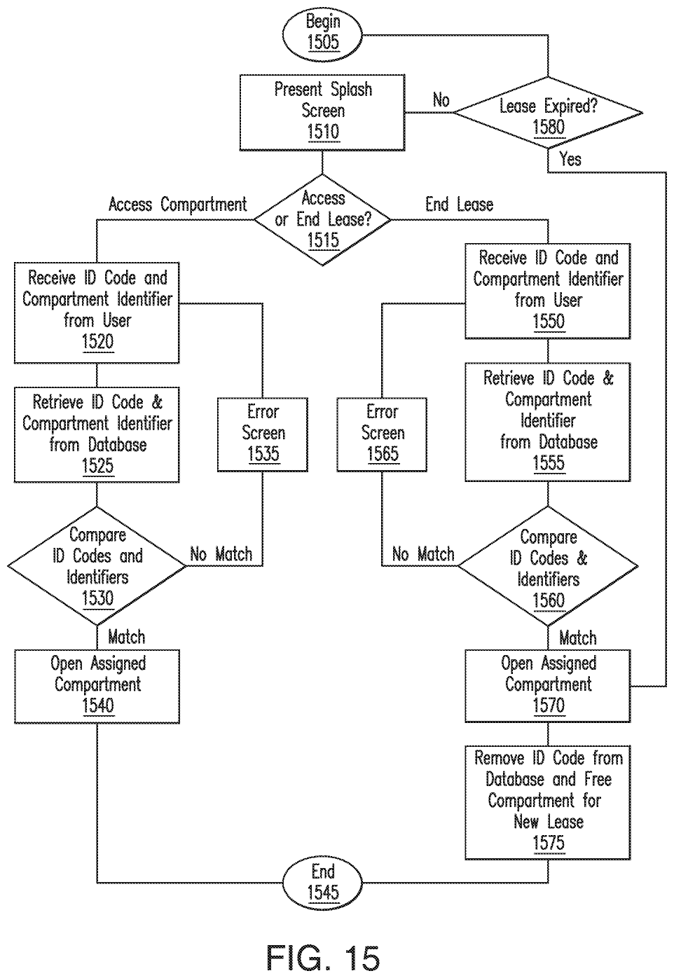

Referring now to FIG. 15, there is seen a process for accessing and ending a user's lease of an assigned storage compartment 110 of a limited-access storage system 100 configured as a ride storage system 100 that previously set the duration of the user's lease to equal the approximate duration of an associated event (e.g., a ride, a concert, a sporting event, etc.) plus an optional overflow duration. While the access/end procedure of FIG. 15 is described below as being performed using one or more user portals 120, it should be appreciated that a similar access/end procedure can be initiated alternatively from kiosk 115 or other device.

The process beings at step 1505 and proceeds to step 1580, at which processing device 330 of kiosk 115 (or a processing device of administrative computer server 225 or other processing device) determines whether the duration of the user's lease of storage compartment 110 has expired. If the lease duration has not expired (such as when the associated event has not yet ended), the process proceeds to step 1510, where the user is presented with a splash screen similar to or different than the one presented to the user at step 1205 of the process for leasing a storage compartment 110 of a limited-access storage system 100 (see FIG. 12).

After exiting the splash screen, the process proceeds to step 1515, where the user is presented with an option to (i) access his/her leased storage compartment 110 or (ii) end the lease. If the user selects the option to access a leased storage compartment 110, the process proceeds to step 1520, where the user is prompted via portal touchscreen 405, to enter the compartment identifier 530 and personal identification number associated with the leased storage compartment 110. This information is then transmitted by user portal 120 to kiosk 115 via network interface 415 and network medium 205.

In an alternative embodiment, the user may utilize a smart device, such as a smart phone or tablet, to text or SMS message the compartment identifier 530 and personal identification number to an access telephone number assigned to electronic storage system 100 and transmitted to the user's smart device during a compartment lease process, such as the lease process described with respect to FIG. 12. In this embodiment, kiosk 115 receives the text or SMS message from a conventional cellular network or, alternatively, via the Internet using network interface 325, network medium 205, and WAN interface 235. In the event Internet communication is employed, the text or SMS message may be converted using any of a number of online vendors which offer Internet-to-SMS messaging capability (and vice versa) or by a software application executing, for example, on a centralized server connected to the Internet.

In still another embodiment, kiosk 115 retrieves the smart device's telephone number from a conventional caller-ID signal transmitted with the text or SMS message. The retrieved telephone number is compared with the smart device telephone number correlated with compartment identifier 530 and stored in kiosk database 335 or centralized database 230 during a compartment lease process, such as the lease process described with respect to FIG. 6. If the telephone numbers do not match, kiosk 115 disregards the text or SMS message. This embodiment provides additional security by requiring that a text or SMS message for accessing an leased storage compartment 110 be transmitted from the smart device telephone number registered with kiosk 115 during the lease process.

In yet another embodiment, the user need only text or SMS message the personal identification code. In this embodiment, kiosk 115 uses the smart device's telephone number retrieved from caller-ID to lookup the compartment identifier 530 associated with the leased storage compartment 110.

The process then proceeds to step 1525, where kiosk 115 retrieves the personal identification code and compartment identifier 530 that were stored previously in centralized database 230 and/or kiosk database 335 during the lease process.

The process then proceeds to step 1530, where kiosk 115 compares the retrieved identification code and compartment identifier 530 with the code and identifier 530 entered by the user at step 1520. If the identification codes and/or compartment identifiers 530 do not match, the process proceeds to step 1035, where kiosk 115 transmits information indicative of the mismatch to user portal 120, which may then present the user with an error message (such as “Incorrect Code” or other suitable message) via portal touchscreen 405. The process then proceeds to step 1520, where the user is re-prompted for his/her personal identification code and compartment identifier 530.

If the codes match, the process proceeds to step 1540. At this step, kiosk 115 communicates information indicative of the match to user portal 120, which may then present the user with a message such as “success” or other suitable message informing the user that a match has occurred. In the event of a match, kiosk 115 also transmits an unlock signal to the locking mechanism 515 associated with the assigned storage compartment 110, thereby causing door 510 of the leased storage compartment 110 to unlock and open automatically to permit access thereto. The process then ends at step 1545.

After the access process is completed, the user locates the leased storage compartment 110 using compartment identifier 530. An indicator light (not shown) on or adjacent to door 510 of compartment 110 may provide a visual indication to aid the user in locating the leased storage compartment 110. After the user locates and places/removes his/her personal belongings in the leased storage compartment 110, the compartment is secured by closing door 510, which automatically engages the associated locking mechanism 515 within rail 125. While limited-access storage system 100 permits the user to access his/her leased storage compartment 110 an unlimited number of times during the lease period, it should be appreciated that limited-access storage system 100 may permit the user to access the leased storage compartment 110 only a limited number of times, such as, for example, only once. Depending on the circumstances, limited access may advantageously prevent abuse of limited-access storage system 100, for example, when storage system 100 is intended to provide a user only with only temporary storage while he/she attends an event or accesses a ride (presumably, in which case, only a single access would be necessary once the event or ride is completed).

If the user selects the option to end a lease at step 1515, the process proceeds to step 1550. At this step, the user is prompted via portal touchscreen 405 to enter the compartment identifier 530 and personal identification number associated with the leased storage compartment 110. This information is then transmitted by user portal 120 to kiosk 115 via network interface 415 and network medium 205.

The process then proceeds to step 1555, where kiosk 115 retrieves the personal identification code and compartment identifier 530 that were stored previously in centralized database 230 and/or kiosk database 335 during the lease process.

The process then proceeds to step 1560, where kiosk 115 compares the retrieved identification code and compartment identifier 530 with the code and identifier 530 entered by the user at step 1550. If the identification codes and/or compartment identifiers 530 do not match, the process proceeds to step 1565, where kiosk 115 transmits information indicative of the mismatch to user portal 120, which may then present the user with an error message (such as “Incorrect Code” or other suitable message) via portal touchscreen 405. The process then proceeds to step 1550, where the user is re-prompted for his/her personal identification code and compartment identifier 530.

If the codes match, the end lease process proceeds to step 1570. At this step, kiosk 115 communicates information indicative of the match to user portal 120, which may then present the user with a message such as “success” or other suitable message informing the user that a match has occurred. In the event of a match, kiosk 115 also transmits an unlock signal to the locking mechanism 515 associated with the leased storage compartment 110, thereby causing door 510 of the leased storage compartment 110 to unlock and open automatically to permit access thereto.

At step 1575, kiosk 115 removes from centralized database 230 and/or kiosk database 335 the stored personal identification code associated with the leased storage compartment 110 and frees the storage compartment 110 for subsequent lease. The user is then free to access storage compartment 110 one last time to remove his/her personal belongings, after which (i.e., upon closing door 510 of compartment 110) he/she is no longer permitted access to storage compartment 110. The process then ends at step 1545.

Referring back to step 1580, if the duration of the user's lease of storage compartment 110 expires before he/she accesses his/her leased compartment 110 or ends his/her lease, the process of FIG. 15 proceeds directly to step 1570, at which the leased storage compartment 110 is opened and freed for subsequent lease at step 1575. As this access of storage compartment 110 occurs automatically without manual intervention, the user may be incentivized to ensure he/she returns to limited-access storage system 100 in a timely fashion to prevent theft of his/her personal items. This, of course, may prevent abuse of limited-access storage system 100, such as, for example, if the user attempts to utilize limited-access storage system 100 to unfairly obtain locker services free of charge and with no intent of attending the associated event. In an alternative embodiment, expiration of the lease duration results in a stored credit card number (such as a credit card number received from the user during the lease process outlined in FIG. 12) being charged a certain amount, either for a set duration or for hourly, continued usage. In still another embodiment, expiration of the lease duration results in a lockout of the leased storage compartment 110, requiring the user to wait until a set time to access his/her compartment or to request access from managing personnel, who may assess a penalty (such as payment and/or ejection from the venue) as a condition precedent to providing access.

In an alternative embodiment, each user portal 120 is operable to permit access only to a subset of storage compartments, such as, for example, only storage compartments 110 in a column immediately adjacent to the user portal 120. This embodiment advantageously reduces queuing at user portals 120 by effectively splitting the user group into smaller subsets, each of which is required to use only a specific user portal 120 for accessing assigned storage compartments 110. Queuing may be reduced even further by ensuring that a lease process, such as the lease process described with respect to FIG. 12, more evenly distributes successive leases of storage compartments 110 among different user portals 120. For example, in an embodiment where each user portal 120 permits access only to storage compartments 110 in a column immediately adjacent the user portal 120, a lease process may advantageously assign storage compartments 110 in such as a way so as to better ensure that storage compartments 110 are distributed more evenly among columns.

With respect to embodiments employing a user portal 120 on each door 510 of storage compartment 110, each portal 120 may be configured to perform lease functions (such as those described with respect to FIGS. 12 and 15) with respect to any storage compartment 110 of limited-access storage system 100. In another embodiment, each door mounted user portal 120 is configured to perform lease functions only with respect to the storage compartment 110 on which it is installed.

Referring back to FIG. 2, as described above, local Area Network (LAN) 220 permits electronic storage systems 100a, 100b, 100c, 100d, . . . 100n to communicate with one or more sensors 250a, 250b, 250c, . . . 250n configured to sense at least one trigger or characteristic associated with the venue and/or a user of an electronic storage system 100a, 100b, 100c, 100d, . . . 100n and to communicate a sensor signal to kiosk 115, administrative computer server 225 or other device indicative of the sensed trigger or characteristic. Kiosk 115 (or administrative computer server 225 or other processing device situated within or outside of electronic storage system 100a) is operable to modify a parameter of the user's lease of one or more storage compartments 110 in accordance with the sensor signal and, more particularly, in accordance with the trigger or characteristic sensed by sensor 250.

### User Location Trigger or Characteristic

In some embodiments, sensors 250a, 250b, 250c, . . . 250n may include one or more user-location sensors 250 operable to detect a trigger or characteristic indicative of the location of a user of a storage system 100 within the venue. For this purpose, user-location sensor 250 may include, for example, one or more RFID scanners situated throughout the venue and operable to detect the presence of a user-specific RFID chip carried by the user, such as an RFID chip embedded within a wrist-band or other object assigned by or associated with the venue. Detection of the user-specific RFID transponder within proximity of a specific RFID scanner (the location of which is known beforehand) can then be used to at least approximate (and, in some embodiments, pinpoint) the location of the user within the venue. In one embodiment, multiple RFID scanners (or other location sensors) are assigned to an event and situated as a GEO-fence thereabout such that proximity of the user to the associated event may be determined with better accuracy. User-location sensors 250 may also include one or more monitoring cameras situated throughout the venue. Such cameras are operable to monitor patrons of the venue and, using appropriate hardware and/or software, detect the presence of specific users based on facial recognition or other detectable biometric characteristics. Detection of a specific user combined with knowledge concerning the locations of the monitoring cameras throughout the venue may then be used to determine the approximate (or precise) position of the specific user within the venue. While embodiments described herein disclose the use of RFID scanners and cameras, it should be appreciated that other embodiments may employ any known hardware and/or software system for detecting the location of users, and that the invention as a whole is not intended to be limited to any specific method or system for detecting the location of users.

### End-of-Event Trigger or Characteristic

In some embodiments, sensors 250a, 250b, 250c, . . . 250n may include one or more end-of-event sensors 250 operable to detect the end or cessation of an associated event at the venue, such as a ride, concert or sporting event. With respect to a ride, for example, the end-of-event sensor 250 may include one or more RFID scanners and transponders, trip sensors, or other mechanisms situated in such a manner so as to detect the end of the ride. For instance, an RFID transponder on the last car of a roller-coaster may be detected by an RFID scanner within proximity of the end of the ride. In other embodiments in which rides include electronic systems that already detect the end of a ride (such as electronic operating systems designed to detect multiple characteristics of a roller-caster or other ride, such as the location of cars), information concerning the end of the ride may be communicated to limited-access storage system 100 via a suitably designed interface. With respect to other events, such as concerts and sporting events, end-of-event information may be communicated to limited-access storage system 100 in similar fashion, manually or by other means. Of course, it will be appreciated that various embodiments contemplate use of any and all known hardware, software and/or other systems for or capable of detecting the end of an event, and that the invention as a whole is not intended to be limited to any particular means for doing so. It should also be appreciated that similar sensors may be employed to detect other aspects or features of an event, such as the beginning of an event, a half-time show or other time marker with respect to the event, etc.

### Environmental Trigger or Characteristic

In some embodiments, sensors 250a, 250b, 250c, . . . 250n may include one or more environmental sensors 250 operable to detect an environmental trigger or characteristic, such as the weather. Detection of weather conditions may be effectuated manually or via online services and/or other vendors who predict or report on weather conditions. In such instances, information concerning weather conditions may be communicated to storage system 100 via a suitably designed interface. In other embodiments, off-the-shelf weather detection equipment may be used, such as doppler radar and pulsed amplifier weather systems, or any of other multiple known technologies in the art for detecting weather conditions. Of course, it should be appreciated that the invention as a whole is not intended to be limited to any particular means or system for detecting weather characteristics or triggers.

### Date/Time Trigger or Characteristic

In some embodiments, sensors 250a, 250b, 250c, . . . 250n may include one or more Date/Time sensors 250 operable to detect a specific date and/or time of day. Date and/or time of day may be detected via any of known methods for detecting or obtaining the date and/or time (such as via online sources, a clock or timer, manually, etc.). Of course, it should be appreciated that the invention as a whole is not intended to be limited to any particular means or system for detecting or obtaining date and/or time information.

### Object Presence Trigger or Characteristic

In some embodiments, sensors 250a, 250b, 250c, . . . 250n may include one or more object-presence sensors 250 operable to detect whether a leased storage compartment 110 includes one or more personal items. Presence of items may be detected using a scale sensor configured to detect the presence of additional weight, cameras, or any other suitable sensor operable to detect the presence of items within leased storage compartment 110. Of course, it should be appreciated that the invention as a whole is not intended to be limited to any particular method or system for detecting the presence of personal items inside a leased storage compartment 110.

### Modification of Lease Parameters Based on Location Trigger or Characteristic

The location of a specific user may be used by kiosk 115, administrative computer server 225 or other system to modify at least one parameter of the user's lease of a storage compartment 110, such as the duration and/or cost of the lease. For instance, where a limited-access storage system 100 is provided free of charge only for temporary storage while users enjoy an associated event (such as a concert, sporting event, ride, such as a roller-coaster, or the like), such users would be expected to stay within the proximity of the event for the entirety of its duration. Detection of a user at another location within the venue before the event ends (such as a concession stand, other ride, bathroom, arcade, etc.) or failure to detect the user at all (such as if the user leaves the venue) may indicate unsanctioned use of limited-access storage system 100. In such an instance, kiosk 115, administrative computer server 225 or other system, for example, may end the lease of the user's storage compartment 110 or limit the duration of the lease. Kiosk 115, administrative computer server 225 or other system may also lock-out the lease (see FIG. 15 and accompanying description) and/or charge the user's credit card number a certain amount, either for a set duration or for hourly, continued usage of limited-access storage system 100 (such as when a credit card number is received from the user during the lease process outlined in FIG. 12 or at some other time, such as when paying for admission to the venue).

In an alternative embodiment, the duration and/or cost of the lease is modified depending on whether the user is detected at an event or in a queue for the event. For instance, if the user is detected in an unusually long queue (or otherwise is detected as standing within the queue for longer than expected) or if the user is detected at an event lasting for longer than expected (such as when a ride is paused for safety reasons or a concert ends with multiple unexpected encores), the duration of the user's lease may be extended automatically to compensate for the additional time. On the other hand, if the user is detected leaving the queue or the event early, it may be inferred that the user has changed his/her mind about attending the event. In such an instance, the duration of the lease may be limited, for example, to a short, set amount of time sufficient to permit the user to return to limited-access storage system 100 and recover his/her belongings. In another embodiment, the original duration of the lease is restored if the user is detected re-entering the queue or event within a specified time. In yet another embodiment, sensors 250 monitor the length of the queue itself irrespective of whether users of limited-access storage system 100 are standing therein and modify the lease duration or cost in accordance with the length of the queue. The length of the queue may be monitored using any suitable method or system, such as, for example, one or more sensors 250 that include cameras coupled with hardware and/or software running object recognition software.

In still another alternative embodiment, the duration and/or cost of the lease is modified depending on whether the user is identified at a certain checkpoint associated with the event. For example, in one embodiment, limited-access storage system 100 monitors whether the user is present at an exit to an event after it ends. If so, it may be inferred that the user participated in or observed the associated event and, as such, that his/her continued use of limited-access storage system 100 is justified. In such an instance, kiosk 115, administrative computer server 225 or other system, for example, may increase the duration of the user's lease to provide him/her with time sufficient to return to limited-access storage system 100 and collect his/her belongings. On the other hand, if the user is not detected at the exit checkpoint, kiosk 115, administrative computer server 225 or other system may take appropriate action, such as, for example, by ending the lease, limiting the duration of the lease, and/or charging the user for continued use of the limited-access storage system 100. In another related embodiment, the user is initially charged for the lease, after which detection of the user at the exit checkpoint operates to refund the user's purchase price and/or begin a free-rental period. In still another alternative embodiment, the checkpoints may be set to other locations associated with the event.

In yet another alternative embodiment, the duration and/or cost of the lease is modified depending on location characteristics of other users of limited-access storage system 100. For example, if a certain percentage of event participants (e.g., 50%, 75%, or other percentage) return to storage system 100 to collect their belongings earlier than expected, it may be inferred that the event itself terminated earlier than expected. In such a case, kiosk 115, administrative computer server 225 or other system, for example, may self-regulate leases by (i) limiting the duration of those leases assigned to one or more users who have not yet returned to system 100 to collect their belongings and/or (ii) charge the users for additional lease time. Of course, similar to the embodiments described above, kiosk 115, administrative computer server 225 or other system, for example, may also lock-out the leases (see FIG. 15 and accompanying description) and/or charge the users' credit card numbers certain amounts, either for set durations or for hourly, continued usage of limited-access storage system 100. kiosk 115, administrative computer server 225 or other system may also use this information to adjust the initial duration of future leases. For example, if a majority of event participants return to storage system 100 earlier than expected, kiosk 115, administrative computer server 225 or other system may reduce the duration of future leases to ensure that initially assigned lease durations best approximate the actual duration of the associated event. In this manner, embodiments of the present invention provide a feedback mechanism that optimizes lease durations.

### Modification of Lease Parameters Based on End-of-Event Trigger or Characteristic

Whether an associated event has ended (or is continuing) may be used by kiosk 115, administrative computer server 225 or other system to modify at least one parameter of a user's lease of a storage compartment 110, such as the duration and/or cost of the lease. With respect to a limited-access storage system 100 associated with an event, the duration of the lease is typically set equal to the expected duration of an event plus an optional overflow duration (e.g., five to ten minutes) to provide sufficient time for the user to exit the event and make his/her way back to limited-access storage system 100 to collect his/her personal items. Kiosk 115, administrative computer server 225 or other system may modify the lease duration depending on the sensed end-of-event trigger or characteristic, for example, by increasing or decreasing the duration, depending on whether the event ends earlier or later than expected.

In another embodiment, the duration of the lease is open-ended (i.e., not set beforehand). The system detects the end-of-event trigger or characteristic, after which the user is provided with a set amount of time to return to limited-access storage system 100.

### Modification of Lease Parameters Based on Environmental and Date/Time Triggers or Characteristics

Environmental conditions (such as the weather), date or time of day may be used by kiosk 115, administrative computer server 225 or other system to modify the duration and/or cost of the user's lease. For example, a storage system 100 may increase the duration of a lease and/or reduce its cost (in some embodiments, to $0.00) if rain, snow or other undesirable weather event is detected. Duration and cost variables may also be adjusted depending on time of day (for instance, system 100 may increase lease duration and/or reduce lease cost near or at the end or beginning of the day in order to encourage users to spend more time at a venue). User participation at a venue may also be encouraged by offering favorable lease durations and costs on off-peak dates or reduced duration and/or increased costs on peak dates, such as holidays.

### Modification of Lease Parameters Based on Object-Presence Triggers or Characteristics

Limited-access storage system 100 may modify one or more lease parameters of a user's lease depending on whether personal items of the user are detected within leased storage compartment 110. For instance, failure to detect items within leased storage compartment 110 may cause storage system 100 to terminate or reduce the duration of the lease. In another embodiment, cost of the lease is reduced if personal items are not detected. This embodiment advantageously ensures that a user is not charged when a leased compartment 110 is not in use (for instance, when a user purchases a full-day lease of compartment 110).

### Modification of Lease Parameters Based on Layered Triggers or Characteristics

In some embodiments, limited-access storage system 100 may modify one or more lease parameters based on a “layered” detection of triggers or characteristics (i.e., a certain chronology, pattern, or sequence of sensed triggers or characteristics). For example, in some embodiments, limited-access storage system 100 monitors whether the user is first present at an entrance to an event before it begins and then at an exit to the event after it ends. If the user is detected at both locations at proper times, it may be inferred that the user participated in or observed the associated event and, as such, that his/her continued use of limited-access storage system 100 is justified. In such an instance, kiosk 115, administrative computer server 225 or other system, for example, may increase the duration of the user's lease to provide him/her with time sufficient to return to limited-access storage system 100 and collect his/her belongings. On the other hand, if the user is not detected at the entrance and exit checkpoints at appropriate times, kiosk 115, administrative computer server 225 or other system may take appropriate action, such as, for example, by ending the lease, limiting the duration of the lease, and/or charging the user for continued use of limited-access storage system 100.

In other embodiments, limited-access storage system 100 monitors whether the user is first present at an event and then present at an associated vendor after completion of the event. For instance, it is not uncommon at amusement parks for systems or personnel to photograph users enjoying events, and then sell such photographs to the associated users immediately after completion of the events, such as at vendor booths associated with and in close proximity to the events. In such an instance, a user may be discouraged from visiting the vendor booth out of fear that his/her lease will be terminated or that his/her credit card will be charged for continued use of leased storage compartment 110. To address this concern, limited-access storage system 100 monitors whether the user is first present at the exit to an event after it ends and then at the vendor booth within a set time thereafter. If the user is detected at both locations at proper times, it may be inferred that the user participated in or observed the associated event and desires to purchase photographs of his/her participation thereat. In such an instance, kiosk 115, administrative computer server 225 or other system, for example, may increase the duration of the user's lease to provide him/her with time sufficient to return to limited-access storage system 100 and collect his/her belongings.

In other embodiments, layered detection of triggers and characteristics allows limited-access storage system 100 to regulate a lease based on aspects of an event that are not determinable beforehand. For example, with respect to concerts, it is typically unknown beforehand whether a performer will perform an encore and, if so, how many he/she will perform. As such, it may be difficult to set an initial lease duration as the precise duration of the event may be difficult to estimate. In such an instance, limited-access storage system 100, for example, may set an initial lease duration equal to an expected default duration of the event with a set number of encores (e.g., zero or one encore), and then increase the duration of the lease a set amount for each encore detected by an appropriately positioned and configured sensor 250.

It should be appreciated that, although the embodiment described above monitors for a sequence of certain triggers and characteristics, the present invention as a whole is not intended to be limited to any particular sequence thereof. Indeed, other embodiments of the present invention contemplate regulation of lease parameters based on any sequence of any number of triggers or characteristics.

### Rewards/Adverts Based on Triggers or Characteristics

In some embodiments, limited-access storage system 100 is operable to provide a user with one or more rewards based on proper use of limited-access storage system 100. For instance, if system 100 detects that the user leases a storage compartment 110 in a sanctioned manner and without intent to abuse (such as when the user is properly detected at an event after leasing compartment 110), limited-access storage system 100 may provide the user with an increased lease duration, lower lease cost, coupon (such as a coupon for a beverage, food, or future admission to the venue), or other reward to show appreciation, to encourage continued attendance at the venue and/or to enhance the goodwill between the user and the venue. It should be appreciated that the present invention is not intended to be limited to any particular reward or detected trigger or characteristic, and that other embodiments of the present invention contemplate providing any kind or type of reward for the detection of any trigger and/or characteristic (or series of triggers and/or characteristics).

In some embodiments, advertisements may be presented to the user based on one or more detected triggers and/or characteristics (or a series of detected triggers and/or characteristics). Advertisements may be presented to the user on digital screens, printed coupons or the like. For instance, in one embodiment, limited-access storage system 100 presents the user with an advertisement for a beverage or related coupon upon detection of a ride completion and a weather characteristic, such as a high temperature. The location of the user may be used to present the advertisement and/or coupon on a digital screen within proximity to the user. Alternatively, the advertisement and/or coupon may be presented to the user on kiosk touchscreen 310 and/or portal touchscreen 405 when he/she returns to limited-access storage system 100 to collect his/her belongings. The advertisement may also be printed for the user via kiosk printing device 320 or portal printer 440 or, alternatively, be SMS messaged to the user's smartphone or tablet. Advertisements may also be personalized based on information received from the user when purchasing admission to the venue or leasing storage compartment 110.

It should be appreciated that, while various embodiments of the present invention are described herein with respect to limited-access storage system 100, the same and all other contemplated embodiments may be employed with respect to full-service storage systems as well. Further, while the present invention has been illustrated by description of various embodiments and while those embodiments have been described in considerable detail, it is not the intention of applicants to restrict or in any way limit the scope of the invention to such details. Additional advantages and modifications will readily appear to those skilled in the art. The invention in its broader aspects is therefore not limited to the specific details and illustrative examples shown and described. Accordingly, departures may be made from such details without departing from the spirit or scope of the invention.

What is claimed is:

1. A storage system operable by a user at a venue, comprising:
a plurality of securable units within the housing;
a processing device, the processing device being configured to assign a securable unit to the user in accordance with a lease of the assigned securable unit and to provide the user with access credentials for accessing the assigned securable unit, the processing device being configured to initially assign at least one lease parameter to the lease; and
a sensor configured to (i) sense at least one trigger or characteristic after the initial lease parameter is initially assigned to the lease and (ii) communicate a sensor signal to the processing device indicative of the sensed trigger or characteristic;
wherein the processing device is configured to modify the at least one lease parameter in accordance with the at least one trigger or characteristic sensed by the sensor.

2. The storage system of claim 1, wherein the processing device is positioned within at least one of a kiosk and an administrative computer server.

3. The storage system of claim 1, wherein the at least one trigger or characteristic includes a location of the user.

4. The storage system of claim 3, wherein the at least one lease parameter includes a duration of the lease.

5. The storage system of claim 4, wherein the processing device is configured to modify the duration of the lease in accordance with the location of a user.

6. The storage system of claim 5, wherein the processing device is operable to reduce the duration of the lease based on the location of the user.

7. The storage system of claim 6, wherein the location of the user is not proximate to an associated event.

8. The storage system of claim 6, wherein the location of the user is not within a queue for an associated event.

9. The storage system of claim 6, wherein the location of the user is not detected at an entrance or exit checkpoint of an associated event.

10. The storage system of claim 3, wherein the at least one lease parameter includes a cost of the lease.

11. The storage system of claim 10, wherein the processing device is configured to modify the cost of the lease in accordance with the location of a user.

12. The storage system of claim 11, wherein the processing device is operable to increase the cost of the lease based on the location of the user.

13. The storage system of claim 12, wherein the location of the user is not proximate to an associated event.

14. The storage system of claim 12, wherein the location of the user is not within a queue for an associated event.

15. The storage system of claim 12, wherein the location of the user is not detected at an entrance or exit checkpoint of an associated event.

16. The storage system of claim 1, wherein the at least one trigger or characteristic includes an end-of-event trigger or characteristic indicative of the end of an associated event.

17. The storage system of claim 16, wherein the at least one lease parameter includes a duration of the lease.

18. The storage system of claim 17, wherein the processing device is configured to modify the duration of the lease in accordance with the end-of-event trigger.

19. The storage system of claim 18, wherein the processing device is operable to reduce the duration of the lease based on the end-of-event trigger.

20. The storage system of claim 19, wherein the location of the user is not proximate to an associated event.

21. The storage system of claim 19, wherein the location of the user is not within a queue for an associated event.

22. The storage system of claim 19, wherein the location of the user is not detected at an entrance or exit checkpoint of an associated event.

23. The storage system of claim 22, wherein the processing device is operable to regulate the at least one lease parameter by continually modifying the at least one lease parameter in accordance with the at least one trigger or characteristic sensed by the sensor, the at least one trigger or characteristic changing over time.

24. The storage system of claim 1, wherein the processing device is configured to modify the at least one lease parameter in accordance with a series of triggers or characteristics sensed by the sensor.

25. The storage system of claim 24, wherein the triggers or characteristics include a location of the user, the processing device being configured to modify the at least one lease parameter if the location of the user is detected first at the exit to an event and then at a sanctioned location.

26. The storage system of claim 25, wherein the sanctioned location is a vendor booth.

27. The storage system of claim 26, wherein the vendor booth is a booth for purchasing photographs.

28. The storage system of claim 1, wherein the trigger or characteristic includes at least one of an environmental characteristic, a date, and a time.

29. The storage system of claim 1, wherein the processing device is operable to regulate the at least one lease parameter by continually modifying the at least one lease parameter in accordance with the at least one trigger or characteristic sensed by the sensor, the at least one trigger or characteristic changing over time.

30. A storage system operable by a user at a venue, comprising:
a plurality of securable units within the housing;
a processing device, the processing device being configured to assign a securable unit to the user in accordance with a lease of the assigned securable unit and to provide the user with access credentials for accessing the assigned securable unit, the processing device being configured to initially assign at least one lease parameter to the lease; and
a sensor configured to (i) sense at least one trigger or characteristic after the initial lease parameter is initially assigned to the lease and (ii) communicate a sensor signal to the processing device indicative of the sensed trigger or characteristic;
wherein the processing device is configured to present an advertisement or reward to the user in accordance with the at least one trigger or characteristic sensed by the sensor.

31. The storage system of claim 30, wherein the reward is a coupon.

32. The storage system of claim 30, wherein the advertisement or reward is presented on a screen in proximity to a location of the user.

33. The storage system of claim 30, wherein the advertisement or reward is presented to the user via a user interface panel.

34. The storage system of claim 30, wherein the advertisement or reward is presented to the user via a smart device.

35. The storage system of claim 30, wherein the at least one trigger or characteristic includes a location of the user.

36. The storage system of claim 35, wherein the processing device is configured to present the advertisement or reward to the user if the location of the user is consistent with attendance at an associated event.

37. The storage system of claim 30, wherein the processing device is operable to regulate the at least one lease parameter by continually modifying the at least one lease parameter in accordance with the at least one trigger or characteristic sensed by the sensor, the at least one trigger or characteristic changing over time.

38. A method of regulating at least one lease parameter, the method comprising:
assigning a securable unit to a user in accordance with a lease of the securable unit;
providing the user with access credentials for accessing the securable unit;
initially assigning the at least one lease parameter to the lease;
sensing at least one trigger or characteristic after the at least one lease parameter is initially assigned to the lease;
communicating a sensor signal indicative of the at least one trigger or characteristic; and
modifying the at least one lease parameter in accordance with the at least one trigger or characteristic.

39. The method of claim 38, wherein the at least one trigger or characteristic includes a location of the user.

40. The method of claim 39, wherein the at least one lease parameter includes a duration of the lease.

41. The method of claim 40, wherein modifying the at least one lease parameter includes reducing the duration of the lease.

42. The method of claim 39, wherein the at least one lease parameter includes a cost of the lease.

43. The method of claim 42, wherein modifying the at least one lease parameter includes increasing the cost of the lease.

44. The method of claim 38, wherein the at least one trigger or characteristic includes an end-of-event trigger or characteristic indicative of the end of an associated event.

45. The method of claim 44, wherein the at least one lease parameter includes a duration of the lease.

46. The method of claim 45, wherein modifying the at least one lease parameter includes reducing the duration of the lease.

47. The method of claim 44, wherein the at least one lease parameter includes a cost of the lease.

48. The method of claim 47, wherein modifying the at least one lease parameter includes increasing the cost of the lease.
